(19) United States
(12) Patent Application Publication
(10) Pub. No.: US 2011/0008723 A1
(43) Pub. Date: Jan. 13, 2011

(54) TONER COLORANT, ELECTROPHOTOGRAPHIC TONER, TWO-COMPONENT DEVELOPER, IMAGE FORMING METHOD, IMAGE FORMING APPARATUS, AND PROCESS CARTRIDGE

(76) Inventors: Tatsuya MORITA, Kanagawa (JP); Kazumi Suzuki, Shizuoka (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/831,627

(22) Filed: Jul. 7, 2010

(30) Foreign Application Priority Data
Jul. 8, 2009 (JP) 2009-161650

(51) Int. Cl. G03G 9/09

(52) U.S. Cl. 430/108.21

(57) ABSTRACT

An electrophotographic toner which is produced by a pulverization method or generated in an aqueous medium, and which includes at least a colorant and a binder reasin, wherein the colorant includes at least a pigment represented by General Formula (1) described below and a fatty acid amide compound,

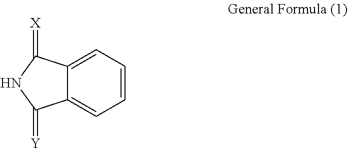

where X and Y are independently selected from the following structures:

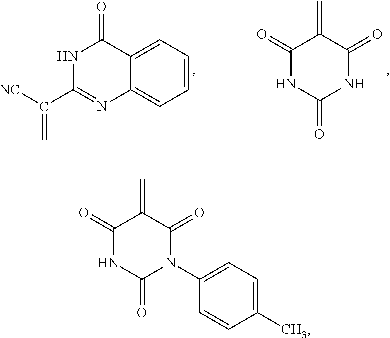

═C(CN)—CONH—CH₃,

═C(CN)—CONH—(C₆H₄)—Z, and

═C(CN)—CONH—(C₆H₃)—Z₂,
where Z denotes one of an alkyl group having 1 to 4 carbon atoms, an alkoxy group and a halogen atom.

### BACKGROUND OF THE INVENTION

1. Field of the Invention

The present invention relates to an electrophotographic toner (for use in image formation), more specifically, relates to an electrophotographic toner for use in so-called image forming apparatuses employing electrophotography, such as electrostatic copiers and laser beam printers, and relates to a two-component developer, an image forming method, an image forming apparatus and a process cartridge each using the electrophotographic toner.

2. Description of the Related Art

The number of sheets processed per hour required for an image forming apparatus has been increasing every year. Therefore, image forming apparatuses are desired to have higher speed performance. With an increase in the demand for high speed performance, image forming apparatuses are required to meet further strict technical conditions. Particularly, in these latter days, electrophotographic technologies are becoming used in on-demand digital printing, toners are required to have high glossiness, a wide fixing offset band and a broad range of color reproducibility. As conventional electrophotographic toners, pulverized toners have been mainly produced. The pulverized toners are produced in a manner in which a pigment and, if necessary, a releasing agent are melt-kneaded with a resin, and the melt-kneaded product is pulverized and then classified so as to be granulated. However, with recent increasing market demands for high-image quality, toner granulation processes based on a polymerization method, by which a toner can have a smaller particle diameter and a narrower particle size distribution, are now most commonly used.

In the toner granulation based on a polymerization method, water and various materials such as a solvent, a surfactant and a dispersion stabilizer are used, the level of the technique required for stabilizing toner materials is further increased. Especially, in granulation of toner particles, the dispersibility of a pigment and a releasing agent used in a resin, which has been dissolved and/or dispersed in a solvent, greatly affects the fixing temperature range and the color reproducibility range of the resulting toner. Thus, the dispersibility of such materials in resins is one of the most important points in toner production methods in which toner particles are granulated with an aqueous medium. Particularly when Color Index No. PY74 is used for a yellow toner, the crystallization of the pigment proceeds due to characteristics of the pigment of suffering from degradation in properties to the solvent and heating, which leads to an increase in diameter of pigment crystalline particles and degradation in absorbing strength, and the degree of coloring and chromaticity of the resulting toner is lower in quality than is expected.

As a solution to the above problems, it has been known that crystal particles of a pigment can be dispersed in a resin without growing from their particles having primary particle diameter irrespective of heat and the type of a solvent used by using Color Index No. PY185 (hereinafter, otherwise referred to as PY185 simply), which is a yellow pigment having high durability to solvents and heat and is represented by the following structural formula (for example, see Japanese Patent Application Laid-Open (JP-A) Nos. 2008-180971, 2007-086714, 2006-293304, 2007-156168, 2006-208758, 2006-113295, 2005-106932, and 06-118715, Japanese Patent (JP-B) Nos. 3073743 and 3065032).

However, when a resin used in a toner has a high acid value, the amide bond contained in PY185 causes aggregation of pigment particles in the granulation of toner. This is considered because an interaction occurs between pigment particles, and the pigment particles tend to be stable because the amide bond contained in the pigment has low solubility in the resin. In this way, when a toner is granulated in an aqueous medium, due to an interaction between a pigment and a resin used in a toner, aggregation of the pigment may occur. When such aggregation of pigment particles occurs, it may cause a degradation of image quality of output images, such as a degradation of color reproducibility and a decrease of degree of coloring, associated with a phenomenon of absorbing surfaces of the pigment particles. In addition, if pigment aggregates are present near the surface of the toner, it is difficult to control the charging amount of the toner, and this may increase the amount of inversely charged toner particles, causing image fogging and nonuniform image density. Therefore, in order to use PY185 as a toner colorant in an aqueous medium, some contrivance to prevent aggregation of pigment particles should be adopted.

### BRIEF SUMMARY OF THE INVENTION

An object of the present invention is to provide a toner colorant which does not cause aggregation of the pigment used and is capable of outputting high-quality images even when the toner colorant is produced by a pulverization process and the toner materials are granulated with an aqueous medium and to provide an electrophotographic toner using the toner colorant. Another object of the present invention is to provide a two-component developer using the electrophotographic toner and to provide an image forming method, an image forming apparatus and a process cartridge each using the electrophotographic toner.

As a result of carrying out extensive studies and examinations on image forming toners, the present inventors have found that the above-mentioned problems can be solved by the following means. More specifically, in order to solve the above-mentioned problems, an image forming toner, a single-component developer and a two-component developer according to the present invention and an image forming method using the toner, an image forming apparatus using the toner and a process cartridge using the toner each have the following technical characteristics (1) to (20).

(1) A toner colorant including:

a pigment represented by General Formula (1) described below, and

a fatty acid amide compound,

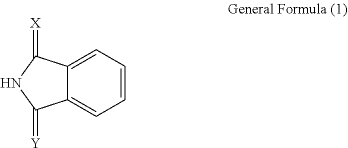

where X and Y are independently selected from the following structures:

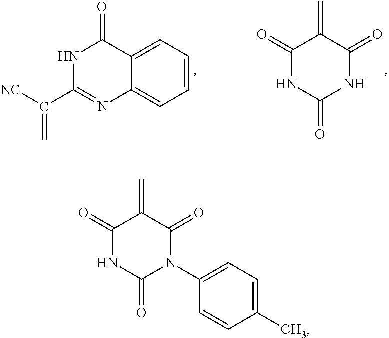

═C(CN)—CONH—CH₃,

═C(CN)—CONH—(C₆H₄)—Z, and

═C(CN)—CONH—(C₆H₃)—Z₂,

where Z denotes one of an alkyl group having 1 to 4 carbon atoms, an alkoxy group and a halogen atom.

(2) The toner colorant according to (1), wherein the amount of the fatty acid amide compound is 12.5 parts by mass to 50 parts by mass per 100 parts by mass of the pigment.

(3) The toner colorant according to one of (1) and (2), wherein the pigment is Color Index Number PY185.

(4) The toner colorant according to one of (1) and (2), wherein the pigment is Color Index Number PY139.

(5) The toner colorant according to any one of (1) to (4), wherein the fatty acid amide compound is one of stearic acid amide and behenic acid amide.

(6) An electrophotographic toner including:

a colorant, and

a binder resin,

wherein the colorant includes at least a pigment represented by General Formula (1) described below and a fatty acid amide compound,

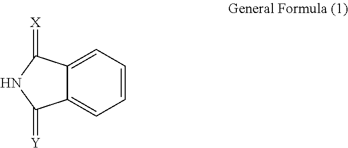

where X and Y are independently selected from the following structures:

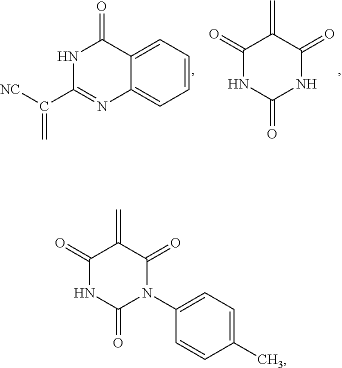

═C(CN)—CONH—CH₃,

═C(CN)—CONH—(C₆H₄)—Z, and

═C(CN)—CONH—(C₆H₃)—Z₂,

where Z denotes one of an alkyl group having 1 to 4 carbon atoms, an alkoxy group and a halogen atom.

(7) The electrophotographic toner according to (6), wherein the electrophotographic toner is produced using a masterbatch which is obtained by previously melt-kneading the binder resin, the pigment and the fatty acid amide compound.

(8) The electrophotographic toner according to (7), wherein the proportion of the pigment to the binder resin, in the masterbatch, is 25 parts by mass to 100 parts by mass per 100 parts by mass of the binder resin.

(9) The electrophotographic toner according to any one of (6) to (8), wherein the pigment is Color Index Number PY185.

(10) The electrophotographic toner according to any one of (6) to (8), wherein the pigment is Color Index Number PY139.

(11) The electrophotographic toner according to any one of (6) to (10), wherein the fatty acid amide compound is one of stearic acid amide and behenic acid amide.

(12) The electrophotographic toner according to any one of (6) to (11), wherein the amount of the fatty acid amide compound is less than 2.0 parts by mass per 100 parts by mass of all resins used.

(13) The electrophotographic toner according to any one of (6) to (12), wherein the pigment is contained in an amount of 1% by mass to 15% by mass.

(14) The electrophotographic toner according to any one of (6) to (13), wherein the amount of the fatty acid amide compound is 12.5 parts by mass to 50 parts by mass per 100 parts by mass of the pigment.

(15) A two-component developer including:

the electrophotographic toner according to any one of (6) to (14), and

a carrier.

(16) An image forming method including:

charging a surface of an image bearing member,

forming a latent electrostatic image on a surface of the image bearing member,

developing the latent electrostatic image using a toner to form a visible image,

transferring the visible image onto a recording medium to form an unfixed image, and

fixing the unfixed image on the recording medium,

wherein the toner for use in forming the visible image is the electrophotographic toner according to any one of (6) to (14).

(17) The image forming method according to (16), wherein a conveyance speed of the recording medium in the fixing is 280 mm/sec or higher.

(18) An image forming apparatus including:

an image bearing member,

a charging unit configured to charge a surface of the image bearing member,

an exposing unit configured to expose the charged surface of the image bearing member to form a latent electrostatic image,

a developing unit configured to develop the latent electrostatic image using a toner to form a visible toner image,

a transfer unit configured to transfer the developed visible toner image onto a recording medium to from an unfixed image, and

a fixing unit configured to fix the unfixed image on the recording medium,

wherein the toner for use in forming the visible image is the electrophotographic toner according to any one of (6) to (14).

(19) The image forming apparatus according to (18), wherein a conveyance speed of the recording medium in the fixing by the fixing unit is 280 mm/sec or higher.

(20) A process cartridge including:

an image bearing member, and

at least one unit selected from a charging unit configured to charge a surface of the image bearing member, an exposing unit configured to expose a charged surface of the image bearing member to form a latent electrostatic image, a developing unit configured to develop a formed latent electrostatic image using a toner, a transfer unit configured to transfer a developed toner image onto a recording medium, and a cleaning unit configured to remove a residual toner remaining on a surface of the image bearing member after transfer of an image, the image bearing member and the at least one unit being integrally provided,

wherein the process cartridge is detachably mounted to a main body of an image forming apparatus,

wherein the toner is the electrophotographic toner according to any one of (6) to (14).

With use of any one of an electrophotographic toner of the present invention, a single component developer using the toner and a two-component developer using the toner, the color reproducibility and the degree of coloring of output images will not substantially degrade and the output images are excellent in image quality, because aggregation of the pigment used is not observed in the course of production process of the toner.

With use the image forming method and the image forming apparatus of the present invention, it is possible to output high-quality images in a stable manner without causing abnormal images even at high-speed processing linear velocity. Further, the image forming method and image forming apparatus of the present invention can be widely utilized in electrophotographic fields (e.g., electrostatic copiers and laser printers).

In addition, according to the process cartridge of the present invention, the toner of the present invention is supplied from a developing unit in the process cartridge, and thus the toner is stably fixed at only desired portions of a recording medium without causing offset phenomena due to unfixed images in a fixing unit, and it is possible to output high-quality images. Furthermore, the process cartridge enables more efficient maintenance management and easy handling.

### BRIEF DESCRIPTION OF THE DRAWINGS

FIG. 1 is a schematic diagram illustrating one example of an image forming apparatus for use in embodiments of the image forming method of the present invention.

FIG. 2 is a schematic diagram illustrating another example of an image forming apparatus for use in embodiments of the image forming method of the present invention.

FIG. 3 is a schematic block diagram illustrating one example of a tandem-type image forming apparatus for use in embodiments of the image forming method of the present invention.

FIG. 4 is a partially enlarged schematic block diagram of the image forming apparatus illustrated in FIG. 3.

FIG. 5 is a schematic block diagram illustrating one example of a process cartridge according to the present invention.

FIG. 6 is an image illustrating a dispersed state of the pigment used in the image forming toner obtained in Example 1.

### DETAILED DESCRIPTION OF THE INVENTION

Hereinbelow, the present invention will be further described in detail, which, however, should not be construed as limiting the present invention in any way.

Electrophotographic toners of the present invention cover both a toner obtainable by a pulverization method (pulverized toner) and a toner produced in an aqueous medium (polymerized toner). The term “pulverized toner” described here means a toner which is obtained by dry-mixing toner materials of at least a binder resin and a colorant, melt-kneading the materials with a kneader, pulverizing the kneaded product, and subjecting the pulverized particles to classification. The term “polymerized toner” described here means a toner obtained through a process in which at least a binder resin and/or a binder resin precursor and a colorant were dissolved and/or dispersed in an organic solvent to prepare an oil phase containing a solution and/or dispersion, the oil phase is dispersed in an aqueous medium to obtain an emulsified dispersion liquid, and then toner particles are granulated.

A colorant for use in the toner of the present invention contains at least a pigment represented by the following General Formula (1), and a fatty acid amide compound.

In the electrophotographic toner containing at least a binder resin and a colorant, the colorant is a pigment represented by the following General Formula (1) and further contains a fatty acid amide compound.

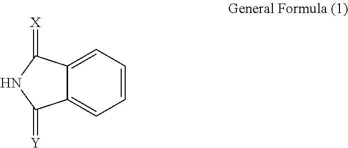

where X and Y are independently a monovalent organic group having 4 to 20 carbon atoms, and more specifically, they are independently selected from the following structures:

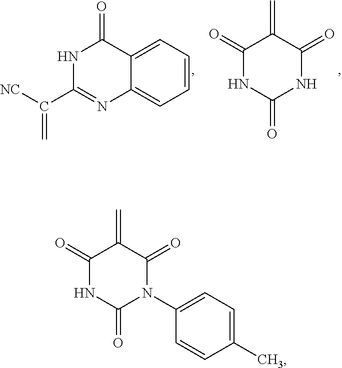

═C(CN)—CONH—CH₃,

═C(CN)—CONH—(C₆H₄)—Z, and

═C(CN)—CONH—(C₆H₃)—Z₂,

(where Z denotes one of an alkyl group (preferably, a methyl group) having 1 to 4 carbon atoms, an alkoxy group and a halogen atom (preferably, a chlorine atom)).

Among these compounds represented by General Formula (1), a compound having the following structural formula is particularly preferable. This pigment is PY185 (a yellow pigment) and is greatly useful in preparation of toner colorants.

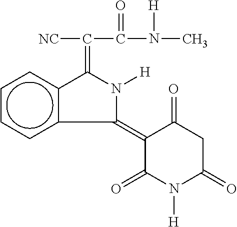

Here, the yellow pigment (PY185) is selected for the pigment, and the following describes melt-kneading of the pigment, the binder resin and the fatty acid amide compound.

### (Melt-Kneading of Yellow Pigment (PY185), Binder Resin and Fatty Acid Amide)

That is, in order to solve the above-problems, it is preferable to previously melt-knead the yellow pigment (PY185) with the binder resin and fatty acid amide compound. The reason why a fatty acid amide compound is preferably used is that with use of a resin containing both an amide having high affinity with an amide bond or amine group contained in the PY185 and a fatty acid, which is a hydrocarbon group having high affinity with a binder resin, dispersion stability of the pigment proceeds in the resin to prevent the pigment from aggregating and being eccentrically located in the resin, and thereby an image can be output with a wider range of color production and color reproducibility. In addition, melt-kneading of such a fatty acid amide compound with the pigment and a resin in advance makes it possible for the fatty acid amide to exhibit its effect of dispersing the pigment. This is because by covering the surface of the pigment with a resin, the pigment can be easily dispersed. If the fatty acid amide is not premixed with these materials, pigment particles are granulated into toner particles in a state where the pigment particles have been already aggregated in granulation of toner particles, and thus an expected effect cannot be obtained, inducing an eccentric location and/or aggregation of the pigment particles, causing a degradation of image quality of output images.

The addition amount of the fatty acid amide is preferably less than 2.0 parts by mass, more preferably 0.1 parts by mass to 1.5 parts by mass, and particularly preferably 0.1 parts by mass to 1.0 part by mass, per 100 parts by mass of all resins used. When the addition amount of the fatty acid amide is less than 0.1 parts by mass, the effect of adding the fatty acid amide cannot be exhibited and the pigment is not uniformly dispersed in the resin. When the addition amount is more than 1.0 part by mass, it is unfavorable in that the viscosity of the resin significantly decreases depending on the type of fatty acid amide used and conditions for producing a toner, which may lead to a degradation of heat resistant storage stability.

Further, the proportion of the pigment to the binder resin in melt-kneading is preferably 25 parts by mass to 100 parts by mass per 100 parts by mass of the binder resin. When the proportion of the pigment to the binder resin is higher than 100 parts by mass, the viscoelasticity of the premixed product increases, and not only a higher shearing force is necessary in kneading the premixed product but also the pigment cannot be uniformly dispersed. When the proportion of the pigment is less than 25 parts by mass, no problem occurs, but the lower the proportion of the pigment is, the more disadvantageous in transportation cost per weight. Therefore, it is desired to previously melt-knead the pigment at the highest proportion.

This tendency is conspicuous particularly when the yellow pigment PY185 is used. The reason is that with use of a compound having an amide bond or an amine group at its end of the molecular structure like PY185, particularly, an interaction between pigment particles becomes stronger, and the binding force of the fatty acid amide with amine groups can be increased. For this reason, the effect of preventing aggregation and eccentric location of the pigment is more easily obtained than with any other pigment.

### (Fatty Acid Amide)

In the present invention, all the generally used saturated and unsaturated fatty acid amides can be used. Examples of the saturated and unsaturated fatty acid amides include, but not limited to, butanoic acid amide, pentanoic acid amide, hexanoic acid amide, heptanoic acid amide, octanoic acid amide, nonanoic acid amide, decanoic acid amide, lauric acid amide, tetradecanoic acid amide, hexadecanoic acid amide, heptadecanoic acid amide, oleic acid amide, vaccenic acid amide, linoleic acid amide, stearic acid amide, linolenic acid amide, eleostearic acid amide, nonadecanoic acid amide, eicosanoic acid amide, behenic acid amide, tetradocosanoic acid amide, hexadocosanoic acid amide, montanoic acid amide, melissic acid amide, crotonic acid amide, myristoleic acid amide, palmitoleic acid amide, oleic acid amide, elaidic acid amide, gadoleic acid amide, eicosenoic acid amide, erucic acid amide, nervonic acid amide, eicosadienoic acid amide, docosadienoic acid amide, pinolenic acid amide, mead acid amide, dihomo-γ-linolenic acid amide, eicosatrienoic acid amide, stearidonic acid amide, arachidonic acid amide, eicosatetraenoic acid amide, adrenic acid amide, bosseopentaenoic acid amide, eicosapentaenoic acid amide, Osbond acid amide, docosapentaenoic acid amide, tetracosaenoic acid amide, docosahexaenoic acid amide, and tetracosahexaenoic acid amide. Especially, from the viewpoint of stability of cost and material quality and easy handling during melt-kneading, it is preferable to use stearic acid amide or behenic acid amide.

### (Binder Resin)

As a resin for use in producing the masterbatch of the present invention, it is preferable to use the same resin material for the binder resin. Conventionally known binder resins are used for such a resin. Specific examples thereof include styrene-based resins (monopolymers and copolymers each containing styrene or a styrene substituent) such as styrene, poly-α-methyl styrene, styrene-chlorostyrene copolymer, styrene-propylene copolymer, styrene-butadiene copolymer, styrene-vinyl chloride copolymer, styrene-vinyl acetate copolymer, styrene-maleic acid copolymer, styrene-acrylate copolymer, styrene-methacrylate copolymer, styrene-α-methyl chloroacrylate copolymer, and styrene-acrylonitrile-acrylate copolymer; polyester resin, epoxy resin, vinyl chloride resin, rosin-modified maleic acid resin, phenol resin, polystyrene resin, polypropylene resin, petroleum resin, polyurethane resin, ketone resin, ethylene-ethyl acrylate copolymer, xylene resin, and polyvinyl butyrate resin. From the viewpoint of fixability of toner, it is particularly preferred to use polyester resins.

The polyester resin can be obtained by a polycondensation reaction of an alcohol component with a carboxylic acid component. The monomer constituting the polyester is not particularly limited, however, the following monomers are exemplified.

Examples of a dihydric alcohol component include ethylene glycol, propylene glycol, 1,3-butanediol, 1,4-butanediol, 2,3-butanediol, diethylene glycol, triethylene glycol, 1,5-pentanediol, 1,6-hexanediol, neopentyl glycol, 2-ethyl-1,3-hexanediol, hydrogenated bisphenol A, or diol obtained by polymerizing a cyclic ether such as ethylene oxide and propylene oxide, with bisphenol A.

In order to crosslink the polyester resin, it is preferable to use a trihydric or higher polyhydric alcohol in combination with the dihydric alcohol. Examples of the trihydric or higher polyhydric alcohol include sorbitol, 1,2,3,6-hexanetetrol, 1,4-sorbitan, pentaerythritol (e.g., dipentaerythritol, tripentaerythritol), 1,2,4-butanetriol, 1,2,5-pentatriol, glycerol, 2-methylpropanetriol, 2-methyl-1,2,4-butanetriol, trimethylolethane, trimethylolpropane, and 1,3,5-trihydroxybenzene.

Examples of the carboxylic acid component forming the polyester-based polymer include benzene dicarboxylic acids such as phthalic acid, isophthalic acid, and terephthalic acid or anhydrides thereof; alkyl dicarboxylic acids such as succinic acid, adipic acid, sebacic acid, and azelaic acid or anhydrides thereof; unsaturated dibasic acids such as maleic acid, citraconic acid, itaconic acid, alkenylsuccinic acid, fumaric acid, and mesaconic acid; and unsaturated dibasic acid anhydrides such as maleic anhydrides, citraconic anhydrides, itaconic anhydrides, and alkenylsuccinic anhydrides.

Examples of trihydric or higher polyhydric carboxylic acid components include trimellitic acid, pyromellitic acid, 1,2,4-benzene tricarboxylic acid, 1,2,5-benzene tricarboxylic acid, 2,5,7-naphthalene tricarboxylic acid, 1,2,4-naphthalene tricarboxylic acid, 1,2,4-butane tricarboxylic acid, 1,2,5-hexane tricarboxylic acid, 1,3-dicarboxy-2-methyl-2-methylenecarboxy propane, tetra(methylenecarboxy)methane, 1,2,7,8-octane tetracarboxylic acid, ENPOL trimer acid, and their anhydrides and partial lower alkyl esters.

### (Glass Transition Temperature (Tg) of Binder Resin)

The binder resin, particularly, the polyester resin preferably used in the present invention desirably has a low glass transition temperature (Tg) within the range not impairing the heat resistant storage stability of the resulting toner. Generally, the Tg is preferably 40° C. to 70° C., and more preferably 60° C. to 65° C. When the Tg is lower than 40° C., a portion of the toner is easily attached to a fixing roller in a fixing process. When the Tg is higher than 70° C., the low-temperature fixability of the toner degrades because the-fixing lower limit temperature becomes higher.

Note that the glass transition temperature (Tg) can be measured using a TG-DSC system (TAS-100) (manufactured by Rigaku Corporation), in the same manner as the after-mentioned Tg of toner.

### (Molecular Weight of Binder Resin)

In order to satisfy both the low-temperature fixability and heat resistant storage stability and to obtain an appropriate glossiness (degree of glossiness) of the image forming toner of the present invention, the resin (e.g., polyester resin) in the toner desirably has a weight average molecular weight (Mw) of about 1,000 to about 500,000. Note that a number average molecular weight (Mn) of the toner may be measured instead of the weight average molecular weight (Mw).

The weight average molecular weight (Mw) or number average molecular weight (Mn) can be measured according to the following manner.

### [Measurement of Weight Average Molecular Weight (Mw)]

The weight average molecular weight (Mw) of the binder resin is measured by GPC (Gel Permeation Chromatography) under the following conditions:
Device: GPC-150C (manufactured by Waters Instruments, Inc.)
Column: KF801 to KF807 (manufactured by Showdex Co.)
Temperature: 40° C.
Solvent: THF (tetrahydrofuran)
Rate of flow: 1.0 mL/min
Sample: 0.1 mL of a sample having a concentration of 0.05% to 0.6% is injected into the column.

Based on a molecular weight distribution of the binder resin measured under the above conditions, a mass average molecular weight of the binder resin is calculated from a molecular weight calibration curve created using a monodispersed polystyrene provided as a standard sample.

### [Measurement of Number Average Molecular Weight (Mn)]

The number average molecular weight (Mn) of the binder resin is measured by GPC under the following conditions:
Device: GPC-150C (manufactured by Waters Instruments, Inc.)
Column: KF801 to KF807 (manufactured by Showdex Co.)
Temperature: 40° C.
Solvent: THF (tetrahydrofuran)
Rate of flow: 1.0 mL/min
Sample: 0.1 mL of a sample having a concentration of 0.05% to 0.6% is injected.

When 1 g of a sample (binder resin) is added to 100 mL of THF, the solvent insoluble fraction is 75% by mass or more, DMF (dimethylformamide) is used as a solvent. The number average molecular weight of the binder resin is calculated from a molecular weight calibration curve created using a monodispersed polystyrene provided as a standard sample.

### (Melt-Kneading Method)

In the melt-kneading of the pigment, fatty acid amide compound and resin, generally known kneaders can be used. More specifically, these materials are sufficiently kneaded using, for example, a biaxial-consecutive kneader (e.g., a KTK type biaxial extruder manufactured by KOBE STEEL., LTD., a TEM type biaxial extruder manufactured by TOSHIBA MACHINE CO., LTD., a PCM type biaxial extruder manufactured by IKEGAI, LTD., and KEX type biaxial extruder manufactured by Kurimoto Ltd.); a uniaxial-consecutive kneader (e.g., a co-kneader manufactured by BUSS, and a kneader manufactured by KCK Co.), or a heating-type kneader, a KNEADEX kneader (manufactured by Mitsui Mining Co., Ltd.).

In the masterbatch of the present invention produced, these constituents such as the binder resin are mixed with a releasing agent and the like, and the masterbatch is used to produce a toner. The amount of the pigment added in the masterbatch is preferably 3 parts by mass to 8 parts by mass, and more preferably 4 parts by mass to 6 parts by mass per 100 parts by mass of the binder resin. This is because when the addition amount of the pigment is more than 8 parts by mass, aggregation of pigment particles easily occurs, which may cause a degradation of image quality.

(Dye/Pigment other than PY185)

A yellow masterbatch of the present invention can be obtained as described above. As colorants (dyes and pigments) for use in the image forming toner of the present invention, any known dyes and pigments can be used.

Examples of the colorants include, but not limited to, carbon black, Nigrosine dyes, black iron oxide, NAPHTHOL YELLOW S, HANSA YELLOW (10G, 5G and G), Cadmium Yellow, yellow iron oxide, loess, chrome yellow, Titan Yellow, polyazo yellow, Oil Yellow, HANSA YELLOW (GR, A, RN and R), Pigment Yellow L, BENZIDINE YELLOW (G and GR), PERMANENT YELLOW (NCG), VULCAN FAST YELLOW (5G and R), Tartrazine Lake, Quinoline Yellow Lake, ANTHRAZANE YELLOW BGL, isoindolinone yellow, red iron oxide, red lead, orange lead, cadmium red, cadmium mercury red, antimony orange, Permanent Red 4R, Para Red, Fire Red, para-chloro-ortho-nitroaniline red, Lithol Fast Scarlet G, Brilliant Fast Scarlet, Brilliant Carmine BS, PERMANENT RED (F2R, F4R, FRL, FRLL and F4RH), Fast Scarlet VD, VULCAN FAST RUBINE B, Brilliant Scarlet G, LITHOL RUBINE GX, Permanent Red FSR, Brilliant Carmine 6B, Pigment Scarlet 3B, Bordeaux 5B, Toluidine Maroon, PERMANENT BORDEAUX F2K, HELIO BORDEAUX BL, Bordeaux 10B, BON MAROON LIGHT, BON MAROON MEDIUM, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, INDANTHRENE BLUE (RS and BC), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone, and mixtures thereof.

### (Colorant Content in Toner)

The amount of the colorant contained in the image forming toner is usually 1% by mass to 15% by mass, and preferably 3% by mass to 10% by mass.

### (Charge Controlling Agent)

The toner of the present invention contains a charge controlling agent as necessary. For the charge controlling agent, any conventionally known charge controlling agents can be used. For example, nigrosine-based dyes, triphenylmethane-based dyes, chrome-containing metal complex dyes, molybdenum acid chelate pigments, rhodamine-based dyes, alkoxy-based amines, quaternary ammonium salts (including fluorine-modified quaternary ammonium salt), alkylamide, single substance or compounds of phosphorous, single substance or compounds of tungsten, fluorine-based active agents, salicylic metal salts, and metal salts of salicylic acid derivatives.

Specific examples of the charge controlling agent include BONTRON 03 of nigrosine dye, BONTRON P-51 of quaternary ammonium salt, BONTRON S-34 of metal-containing azo dye, E-82 of oxy naphthoic acid-based metal complex, E-84 of salicylic acid-based metal complex, and E-89 of phenolic condensate (produced by ORIENT CHEMICAL); TP-302 and TP-415 of quaternary ammonium salt molybdenum complex (produced by HODOGAYA CHEMICAL); COPY CHARGE PSY VP2038 of quaternary ammonium salt, COPY BLUE PR of triphenyl methane derivative, COPY CHARGE NEG VP2036 of quaternary ammonium salt, and COPY CHARGE NX VP434 (produced by Hoechst AG); LRA-901, and LR-147 of boron complex (produced by NIPPON CARLIT); copper phthalocyanine, perylene, quinacridone, and azo pigments; and other polymer compounds having a functional group such as a sulfonic group, carboxyl group, and quaternary ammonium salt.

The charge controlling agent content is suitably determined according to the desired chargeability. It is, however, preferably 0.1% by mass to 10% by mass, and more preferably 0.2% by mass to 5% by mass. When the addition amount is more than 10% by mass, the effect of the charge controlling agent is diminished due to excessively high chargeability of the toner, and the electrostatic attraction force of the toner to a developing roller used increases, which may cause a degradation in flowability of the developer and a degradation in image density. When the addition amount is less than 0.1% by mass, the charge rising capability and the chargeability of the toner may be insufficient, which may adversely affect toner images.

### (Releasing Agent)

In the present invention, a releasing agent is not necessarily used, however, may be added in an appropriate amount if desired. As the releasing agent, a wax having a low melting point of 50° C. to 120° C. efficiently works as a releasing agent between a fixing roller and the toner interface in a dispersion prepared with the binder resin, whereby excellent high-temperature offset resistance can be exhibited without applying an oily releasing agent to a fixing roller.

Examples of such a wax component include plant waxes (e.g., carnauba wax, cotton wax, Japan wax, and rice wax), animal waxes (e.g., bees wax, and lanoline), mineral waxes (e.g., ozokerite, and ceresin); and petroleum waxes (e.g., paraffin, microcrystalline, and petrolatum). Beside these natural waxes, synthetic hydrocarbon waxes such as Fishertropush wax, and polyethylene wax; and synthetic waxes such as ester, ketone, and ether are exemplified. Further, fatty acid amide (e.g., 12-hydroxystearate amide, stearic acid amide, imide phthalate anhydride, and chlorinated hydrocarbon) and a homopolymer or copolymer of polyacrylate, such as poly-n-stearyl methacrylate, and poly-n-lauryl methacrylate (e.g., a copolymer of n-stearyl acrylate-ethyl methacrylate) and a crystalline polymer having a long alkyl group in its side chain can also be used.

### [Example of Toner Production by Pulverization Method]

In the case of a toner of the present invention produced by a pulverization method (production of a pulverized toner), the above-mentioned toner materials are dry-mixed, and then subjected to melt-kneading, pulverization and classification, thereby obtaining the toner.

In order to improve the flowability, storage stability, developing ability and transferability of the toner, inorganic fine particles (external additive) may be added to and mixed with the toner base particles produced as described above. In the mixing of such additives, a common powder-mixer is used. It is preferable in that such a powder-mixer is equipped with a jacket or the like and the temperature of the internal system can be controlled. In order to change the history of the load applied to additives, the additives are added in the middle of the mixing process or by little by little in the mixing process. In this case, the number of revolutions, rate of rolling, time and temperature etc. of the mixer may be changed. In addition, first, a strong load may be applied to the internal system and then a relatively weak load may be applied thereto, and the reverse order may be used. Specific examples of usable mixing instruments include a V-type mixer, rocking mixer, LOEDGE Mixer, NAUTER Mixer and HENSCHEL MIXER. Next, the toner base particles are passed through a sieve having 250 or more meshes so as to remove aggregate particles, and thereby a toner can be obtained.

### (External Additive)

As an external additive used in the present invention, for the purpose of imparting flowability, chargeability and developing ability, inorganic fine particles are preferably used. The primary particle diameter of the inorganic fine particles is preferably 5×10^{-3 μm to} 2 μm, and particularly preferably 5×10⁻³ μm to 0.5 μm. The specific surface area of the inorganic fine particles measured by a BET method is preferably 20 m²/g to 500 m²/g.

The addition amount of the inorganic fine particles is preferably 0.01% by mass to 5% by mass of that of the image forming toner.

Specific examples of the inorganic fine particles include silica, alumina, titanium oxide, barium titanate, magnesium titanate, calcium titanate, strontium titanate, zinc oxide, tin oxide, silica sand, clay, mica, wollastonite, diatomite, chromium oxide, cerium oxide, colcothar, antimony trioxide, magnesium oxide, zirconium oxide, barium sulfate, barium carbonate, calcium carbonate, silicon carbide, silicon nitride.

These external additives can be treated with a surface treatment agent to enhance the hydrophobicity of toner, by which a degradation of flowability and chargeability of toner particles under high-humidity environment can be suppressed. Examples of the surface treatment agent include silane coupling agent, silylating agent, silane coupling agent having fluorinated alkyl group(s), organic titanate coupling agent, aluminum coupling agent, silicone oil, and modified silicone oil.

### [Example of Method of Toner Granulation in Aqueous Medium]

In the case of a toner of the present invention produced in an aqueous medium (production of a polymerized toner), first, the above-mentioned colorant, an unmodified polyester, an isocyanate group-containing polyester prepolymer (A), and the releasing agent are dispersed in an organic solvent to prepare a toner material liquid. (Isocyanate group-containing polyester prepolymer (A))

As the polyester, for example, an isocyanate-containing polyester prepolymer (A) is preferably used, in which a carboxyl group, hydroxyl group or the like present in the end of a polyester obtained by a polycondensation reaction of a polyhydric alcohol (PO) with a polyvalent carboxylic acid (PC) is reacted with a polyvalent isocyanate compound (PIC).

The amount of the components constituting the polyvalent isocyanate compound (PIC) in the isocyanate-containing polyester prepolymer (A) is usually 0.5% by mass to 40% by mass, preferably 1% by mass to 30% by mass, and more preferably 2% by mass to 20% by mass. When the amount is less than 0.5% by mass, the hot offset resistance of the resulting toner degrades, and it is disadvantageous in improving both the heat resistant storage stability and low-temperature fixability. When the amount is more than 40% by mass, the low-temperature fixability of the toner degrades.

The number of isocyanate groups contained per molecule in the isocyanate-containing polyester prepolymer (A) is typically one or more, preferably 1.5 to 3 on the average, and still more preferably 1.8 to 2.5 on the average. When the number of isocyanate groups contained per molecule in the isocyanate-containing polyester prepolymer (A) is less than one, the molecular weight of the resulting urea-modified polyester decreases, resulting in a degradation in hot offset resistance of the resulting toner.

### (Organic Solvent)

As the organic solvent, a volatile organic solvent having a boiling point of less than 100° C. is preferable from the viewpoint of ease of removing of the solvent after formation of toner base particles. Specific examples of the organic solvent include toluene, xylene, benzene, tetrachloride carbon, methylene chloride, 1,2-dichloroethane, 1,1,2-trichloroethane, trichloroethylene, chloroform, monochlorobenzene, dichloroethylidene, methyl acetate, acetic ether, methyl ethyl ketone, and methyl isobutyl ketone. These can be used alone or in combination. Among these, aromatic solvent such as toluene and xylene, halogenated hydrocarbon such as dichloromethane, 1,2-dichloroethane, chloroform, and tetrachloride carbon are preferably used. The use amount of the solvent with respect to 100 parts by mass of the polyester prepolymer (A) is typically 0 parts by mass to 300 parts by mass, preferably 0 parts by mass to 100 parts by mass, and still more preferably 25 parts by mass to 70 parts by mass. The toner material liquid is emulsified, in the presence of a surfactant and resin fine particles, in an aqueous medium.

### (Aqueous Medium)

The aqueous medium may contain water and/or an organic solvent such as alcohol (methanol, isopropyl alcohol, ethylene glycol, etc), dimethylformamide, tetrahydrofuran, cellosolves (methyl cellosolve, etc.), lower-ketones (acetone, methyl ethyl ketone, etc.) or the like.

The use amount of the aqueous medium with respect to 100 parts by mass of the toner material liquid is typically 50 parts by mass to 2,000 parts by mass, and preferably 100 parts by mass to 1,000 parts by mass. When the use amount is less than 50 parts by mass, toner particles having a predetermined particle diameter cannot be obtained due to a poor dispersion state of the toner material liquid. When the use amount is more than 20,000 parts by mass, it is economically disadvantageous.

### (Surfactant and Resin Fine Particle)

Further, dispersants such as a surfactant and resin fine particles are added in suitable amounts so as to improve the dispersion state of the colorant, unmodified polyester, isocyanate group-containing polyester prepolymer, releasing agent and the like.

Examples of the surfactant include anionic surfactants (e.g., alkylbenzene sulfonate, α-olefin sulfonate, and phosphate ester); cationic surfactants such as amine salt surfactant (e.g., alkylamine salt, amino alcohol fatty acid derivative, polyamine fatty acid derivative, and imidazoline), and quaternary ammonium salt (e.g., alkyl trimethyl ammonium salt, dialkyldimethyl ammonium salt, alkyl dimethylbenzyl ammonium salt, pyridinium salt, alkyl isoquinolinium salt, and benzethonium chloride); nonionic surfactants (e.g., fatty acid amide derivative, and polyhydric alcohol derivative); and zwitterionic surfactants (e.g., alanine, dodecyldi(aminoethyl)glycine, di(octylaminoethyl)glycine, and N-alkyl N,N-dimethylammonium betaine).

With use of a surfactant having a fluoroalkyl group, the dispersed state of the above-mentioned materials can be improved with a small amount. Preferred examples of the anionic surfactant having a fluoroalkyl group include fluoroalkyl carboxylic acid having a carbon atoms of 2 to 10 or metal salt thereof, disodium perfluorooctane sulfonyl glutamic acid, sodium 3-[ω-fluoroalkyl (C6 to C11) oxy]-1-alkyl (C3 to C4) sulfonate, sodium 3-[ω-fluoroalkanoyl (C6 to C8)-N-ethylamino]-1-propane sulfonate, fluoroalkyl (C11 to C20) carboxylic acid or its metal salt, perfluoroalkyl carboxylic acid (C7 to C13) or its metal salt, perfluoroalkyl (C4 to C12) sulfonate or its metal salt, perfluorooctane sulfonic acid diethanolamide, N-propyl-N-(2-hydroxyethyl)perfluorooctane sulfonamide, perfluoroalkyl (C6 to C10) sulfonamide propyl trimethyl ammonium salt, perfluoroalkyl (C6 to C10)-N-ethylsulfonyl glycine salt, and mono perfluoroalkyl (C6 to C16) ethylphosphate ester.

Examples of trade name of surfactant having the fluoroalkyl group include SURFLON S-111, S-112, S-113 (manufactured by Asahi Glass Co., Ltd); FLUORAD FC-93, FC-95, FC-98, FC-129 (manufactured by Sumitomo 3M Co., Ltd); UNIDINE DS-101, DS-102 (manufactured by Daikin Industries, Ltd); MEGAFACE F-110, F-120, F-113, F-191, F-812, F-833 (manufactured by Dainippon Ink & Chemicals, Inc.); F-TOP EF-102, 103, 104, 105, 112, 123A, 123B, 306A, 501, 201, 204 (manufactured by Tochem Products Co., Ltd); and FTERGENT F-100, F150 (manufactured by Neos Co., Ltd).

Examples of the cationic surfactant include aliphatic primary, secondary, or tertiary amine having a fluoroalkyl group, aliphatic quaternary ammonium salt, such as perfluoroalkyl (C6 to C10) sulfonamide propyl trimethyl ammonium salt, benzalkonium salt, benzethonium chloride, pyridinium salt, and imidazolinium salt. Examples of trade name of the cationic surfactant include SURFLON S-121 (manufactured by Asahi Glass Co., Ltd); FLUORAD FC-135 (manufactured by Sumitomo 3M Co., Ltd); UNIDINE DS-202 (manufactured by Daikin Industries, Ltd), MEGAFACE F-150, F-824 (manufactured by Dainippon Ink & Chemicals, Inc.); F-TOP EF-132 (manufactured by Tochem Products Co., Ltd); and FTERGENT F-300 (manufactured by Neos Co., Ltd).

As the resin fine particles, any resin can be used as long as it is capable of forming an aqueous dispersion, and it may be a thermoplastic resin or a thermosetting resin. Examples of such resins include vinyl-based resin, polyurethane resin, epoxy resin, polyester resin, polyamide resin, polyimide resin, silicon-based resin, phenolic resin, melamine resin, urea resin, aniline resin, ionomer resin, and polycarbonate resin. These resins may be used in combination.

Among these resins, from the standpoint of ease of obtaining an aqueous dispersion of spherically shaped fine resin particles, vinyl-based resin, polyurethane resin, epoxy resin, polyester resin and combinations thereof are preferable. Examples of the vinyl-based resin include homopolymer or copolymer of vinyl monomers, and may be styrene(meth)acrylic acid ester copolymer, copolymer of styrene-butadiene, copolymer of (meth)acrylic acid-acrylic acid ester, copolymer of styrene-acrylonitrile, copolymer of styrene-maleic anhydride, and copolymer of styrene-(meth)acrylic acid. The average particle diameter of the resin fine particles is typically 5 nm to 200 nm, and preferably 20 nm to 300 nm. Besides, inorganic compound-based dispersants such as tricalcium phosphate, calcium carbonate, titanium oxide, colloidal silica, and hydroxyapatite can also be used.

As a dispersant usable in combination with the resin fine particles and inorganic compound-based dispersant, a polymer-based protective colloid may be used to stabilize dispersion liquid droplets. Specific usable examples thereof include acids (e.g., acrylic acid, methacrylic acid, α-cyanoacrylic acid, α-cyanomethacrylic acid, itaconic acid, crotonic acid, fumaric acid, maleic acid, and maleic anhydride); (meth)acrylic monomer having hydroxyl group (e.g., β-hydroxyethyl acrylic acid, β-hydroxyethyl methacrylic acid, β-hydroxypropyl acrylic acid, β-hydroxypropyl methacrylic acid, γ-hydroxypropyl acrylic acid, γ-hydroxypropyl methacrylic acid, 3-chloro-2-hydroxypropyl acrylic acid, 3-chloro-2-hydroxypropyl methacrylic acid, diethylene glycol monoacrylic ester, diethylene glycol monomethacrylic acid ester, glycerin monoacrylic ester, glycerin monomethacrylic ester, N-methylol acrylamide, and N-methylol methacrylamide); vinyl alcohols or vinyl alcohol ethers (e.g., vinyl methyl ether, vinyl ethyl ether, and vinyl propyl ether); ester compounds having vinyl alcohol and carboxyl group (e.g., vinyl acetate, vinyl propionate, and vinyl butyrate); acrylamide, methacrylamide, diacetone acrylamide or methylol compound thereof; acid chlorides (e.g., acrylic acid chloride, and methacrylic acid chloride); homopolymers or copolymers having nitrogen atoms or a heterocyclic ring of nitrogen atom (e.g., vinylpyridine, vinylpyrrolidone, vinylimidazole, and ethyleneimine); polyoxyethylene compounds (e.g., polyoxyethylene, polyoxypropylene, polyoxyethylene alkylamine, polyoxypropylene alkylamine, polyoxyethylene alkylamide, polyoxypropylene alkylamide, polyoxyethylene nonyl phenyl ether, polyoxyethylene lauryl phenyl ether, polyoxyethylene stearyl phenyl ester, and polyoxyethylene nonyl phenyl ester); and celluloses (e.g., methyl cellulose, hydroxyethyl cellulose, and hydroxypropyl cellulose).

### (Dispersing)

The dispersing method is not particularly limited. For example, known methods, such as a low-speed shearing method, a high-speed shearing method, a friction method, a high-pressure jet method, an ultrasonic wave method can be used. Among these methods, a high-speed shearing method is preferably used to obtain dispersed particles having a particle diameter of from 2 μm to 20 μm. When a dispersing machine is used, the number of revolutions thereof is not particularly limited, however, the dispersing machine is preferably rotated at 1,000 rpm to 30,000 rpm, and more preferably 5,000 rpm to 20,000 rpm. Although a dispersion time can be set any time, the dispersion time is usually set to 0.1 minutes to 5 minutes for a batch method. The dispersion temperature is usually set to from 0° C. to 150° C. (under application of pressure), and more preferably from 40° C. to 98° C. At the same time of preparing an emulsified liquid of the toner materials, amine (B) are added to the aqueous medium to react with the isocyanate group-containing polyester prepolymer (A).

Examples of the amine (B) include diamine (B1), trivalent or more polyamine (B2), amino alcohol (B3), amino mercaptan (B4), amino acid (B5), and compound (B6), in which amino group of (B1) to (B5) is blocked.

Examples of the diamine (B1) include aromatic diamine (e.g., phenylene diamine, diethyl toluene diamine, 4,4′-diaminodiphenylmethane); alicyclic diamine (e.g., 4,4′-diamino-3,3′dimethyldicyclohexylmethane, diaminecyclohexane, isophorone diamine); and aliphatic diamine (e.g., ethylene diamine, tetramethylene diamine, hexamethylene diamine).

Examples of the trivalent or more polyamine (B2) include diethylene triamine, triethylene tetramine. Examples of the amino alcohol (B3) include ethanolamine and hydroxyethylaniline. Examples of the amino mercaptan (B4) include aminoethyl mercaptan and aminopropyl mercaptan. Examples of the amino acid (B5) include aminopropionic acid and aminocaproic acid.

Examples of the compound (B6), in which amino group of (B1) to (B5) is blocked, include ketimine compounds obtained from amines of (B1) to (B5) and ketones (e.g., acetone, methyl ethyl ketone, methyl isobutyl ketone), and oxazoline compounds. Among these amines (B), (B1) alone and a mixture of (B1) and a small amount of (B2) are preferable.

A ratio of the amine (B) is, as an equivalent ratio of [NCO]/[NHx] of isocyanate group [NCO] in the isocyanate group-containing polyester prepolymer (A) and amino group [NHx] in the amine (B), typically from 1/2 to 2/1, preferably from 1.5/1 to 1/1.5, and more preferably from 1.2/1 to 1/1.2. If the ratio [NCO]/[NHx] is more than 2 or less than 1/2, a molecular weight of urea-modified polyester becomes lower, and hot offset resistance may degrade.

Since this reaction is associated with crosslinking and/or elongation of molecular chains, a reaction inhibitor can be used, as required, to adjust a molecular weight of the urea-modified polyester. Examples of the reaction inhibitor include monoamine (e.g., diethylamine, dibutylamine, butylamine, laurylamine) and compounds (e.g., ketimine compound), in which monoamine is blocked.

An elongation and/or cross-linking reaction time is determined based on reactivity of the isocyanate group of the polyester prepolymer (A) and the amine (B). The reaction time is typically 10 minutes to 40 hours, and preferably 2 hours to 24 hours. The reaction temperature is typically from 0° C. to 150° C., and more preferably 40° C. to 98° C. Further, a known catalyst, such as dibutyltin laurate and dioctyltin laurate, can be used, as required.

Further, a mass ratio of the unmodified polyester to the urea-modified polyester is typically 20/80 to 95/5, preferably 70/30 to 95/5, still more preferably 75/25 to 95/5, and particularly preferably 80/20 to 93/7. When the mass ratio of the urea-modified polyester is less than 5%, the hot offset resistance of the hot offset resistance of the resulting toner degrades, and it is disadvantageous in improving both the heat resistant storage stability and low-temperature fixability.

### (Removal of Organic Solvent, Washing, and Drying)

After completion of the reaction, the organic solvent is removed from the emulsified dispersion (reaction product), followed by washing and drying, and thereby toner base particles can be obtained.

To remove an organic solvent from the emulsified dispersion (reaction system), the entirety of the reaction system is gradually heated to a higher temperature while stirring with a laminar flow so that a strong agitation is applied at a constant temperature, followed by removal of the solvent, whereby spindle-shaped toner base particles can be produced. When an acid such as calcium phosphate and/or an alkali-soluble compound is used as a dispersion stabilizer, the calcium phosphate is dissolved in the reaction system with an acid such as hydrochloric acid and then the reaction system is washed with water to thereby remove the calcium phosphate from toner base particles. Besides, an organic solvent can be removed from toner base particles by a treatment such as resolution using enzyme. A charge controlling agent is injected, as an external additive, into the thus toner base particles, and then inorganic fine particles, such as silica fine particles and titanium oxide fine particles, are made to adhere on the toner base particles, thereby obtaining a toner. Note that the injection of a charge controlling agent and the external addition of inorganic fine particles can be carried out by a known method using a mixer or the like.

With the above treatments, a toner having small diameters and a sharp particle size distribution can be easily obtained. Further, by applying a strong agitation to the reaction system in the process of removing an organic solvent, it is possible to control the shape of the resulting toner from a spherical shape to a rugby-ball-shape and to control the morphology of toner surfaces from smooth surfaces to slightly deformed surfaces like those of pickled plum.

### [Particle Diameter of Toner]

The weight average particle diameter of the image forming toner of the present invention is not particularly limited and may be suitably selected in accordance with the intended use. In order to a high-quality image excellent in granularity, sharpness and thin-line reproducibility, the weight average particle diameter is preferably 3.5 μm to 10 μm. The smaller the particle diameter is, the more excellent in sharpness and thin-line reproducibility of images is. Particularly in color image forming apparatuses, there are strict demands to image quality, a toner needs to have a particle diameter of 10 μm or less. Particularly, a toner having a particle diameter of 7.5 μm or less is preferably used to obtain high-quality images. When the toner particle diameter is too small, for example, less than 3.5 μm, the flowability and transferability of the toner degrade. Here, the weight average particle diameter of the toner can be determined as follows.

### (Measurement of Weight Average Particle Diameter (Dw) of Toner)

Examples of a measuring device of a particle size distribution of toner particles by the Coulter Counter method include COULTER COUNTER TA-II and COULTER MULTISIZER III (both manufactured by Coulter Electronics Inc.). In the present invention, a COULTER MULTISIZER III was used to measure a weight average particle diameter of toner particles in the following manner.

First, 0.1 mL to 5 mL of a surfactant (preferably polyoxyethylene alkyl ether) is added as a dispersant in 100 mL to 150 mL of an electrolyte. Here, as the electrolyte, an aqueous solution containing NaCl of about 1% (primary sodium chloride such as ISOTON-II from Coulter Electronics Inc.) can be used. Next, 2 mg to 20 mg of a measurement sample (toner) is added to the electrolyte. The electrolyte, in which the sample is suspended, is dispersed using an ultrasonic dispersing machine for about 1 minute to about 3 minutes to prepare a toner suspension liquid. The volume and the number of toner particles are measured by the above instrument using an aperture of 100 μm to determine a volume average particle size distribution and a number average particle size distribution thereof. Then, from the distributions thus obtained, a weight average particle diameter (Dw) and a number average particle diameter (Dn) can be determined.

In the measurement, the following 13 channels were used to measure particles having diameters of 2.00 μm or larger and smaller than 40.30 μm: a channel having a diameter of 2.00 μm or larger and smaller than 2.52 μm, a channel having a diameter of 2.52 μm or larger and smaller than 3.17 μm; a channel having a diameter of 3.17 μm or larger and smaller than 4.00 μm; a channel having a diameter of 4.00 μm or larger and smaller than 5.04 μm; a channel having a diameter of 5.04 μm or larger and smaller than 6.35 μm; a channel having a diameter of 6.35 μm or larger and smaller than 8.00 μm; a channel having a diameter of 8.00 μm or larger and smaller than 10.08 μm; a channel having a diameter of 10.08 μm or larger and smaller than 12.70 μm; a channel having a diameter of 12.70 μm or larger and smaller than 16.00 μm; a channel having a diameter of 16.00 μm or larger and smaller than 20.20 μm; a channel having a diameter of 20.20 μm or larger and smaller than 25.40 μm; a channel having a diameter of 25.40 μm or larger and smaller than 32.00 μm; and a channel having a diameter of 32.00 μm or larger and smaller than 40.30 μm.

### [Glass Transition Temperature of Toner]

The glass transition temperature (Tg) of the image forming toner of the present invention is preferably 60° C. to 65° C. When the Tg is higher than the above range, the low-temperature fixability of the toner degrades due to an increased lower limit fixing temperature of the toner.

The Tg (DSC maximum endothermic peak) of the image forming toner was calculated from a tangent point between a tangent line of an endothermic curve near the melting point and a base line thereof, using a TG-DSC system (TAS-100) (manufactured by Rigaku Corporation) and an analysis system in the TAS-100.

Specifically, about 10 mg of a toner sample was placed in an aluminum-sample container, the container was mounted on a holder unit of the TG-DSC system and then set in an electric oven. The toner sample was heated from room temperature to 180° C. at a temperature increase rate of 10° C./min, and then based on the obtained endothermic curve, a Tg was calculated.

### [Single Component Developer]

In a single component developer of the present invention, the toner described above can be used as a non-magnetic single component toner or magnetic single component toner (magnetic toner).

When the above-mentioned toner is used as a magnetic toner, a known magnetic material is contained therein. Examples of such a magnetic material include iron oxides such as magnetite, maghemite, and ferrite; metals such as iron, cobalt, and nickel, or metal alloys of these metals with other metals such as aluminum, cobalt, copper, lead, magnesium, tin, zinc, antimony, beryllium, bismuth, cadmium, calcium, manganese, selenium, titanium, tungsten, and vanadium; and mixtures thereof. These ferromagnetic materials desirably have an average particle diameter of about 0.1 μm to about 2 μm. The amount of the ferromagnetic material contained in the toner is preferably 20 parts by mass 200 parts by mass per 100 parts by mass of the binder resin, and particularly preferably 40 parts by mass to 150 parts by mass per 100 parts by mass of resin components.

### [Two-Component Developer]

As a carrier for use in a two-component developer of the present invention, known carriers for two-component developer can be used.

For example, a carrier including magnetic particles of iron, ferrite or the like, a resin-coated carrier having a surface coated with such magnetic particles, a binder-type carrier in which a magnetic fine powder is dispersed in a binder resin, or the like can be used.

As such a magnetic material, iron oxides such as magnetite, maghemite, and ferrite; metals such as iron, cobalt, and nickel, or metal alloys of these metals with other metals such as aluminum, cobalt, copper, lead, magnesium, tin, zinc, antimony, beryllium, bismuth, cadmium, calcium, manganese, selenium, titanium, tungsten, and vanadium; and mixtures thereof can be used.

Among these carriers, it is preferable to use, as a coating resin, a silicone-based resin, a copolymer resin (graft resin) of organosiloxane and a vinyl monomer, or a polyester-based resin from the viewpoint of preventing toner spent and the like. Particularly, a carrier coated with a resin which is obtained by reacting isocyanate with the copolymer resin of organosiloxane and a vinyl monomer is preferable from the viewpoint of the durability, environmental stability and toner-spent resistance.

As the vinyl monomer, it is necessary to use a monomer having a substituent such as a hydroxyl group reactive to isocyanate.

Further, from the viewpoint of ensuring high quality of image and preventing carrier fogging, it is preferable to use a magnetic carrier having a volume average particle diameter of 20 μm to 100 μm, and more preferably 20 μm to 60 μm.

Examples of the other carrier coating resin for use in a carrier include amino resins such as urea-formaldehyde resin, melamine resin, benzoguanamine resin, urea resin, polyamide resin, and epoxy resin; polyvinyl and polyvinylidene resins, acrylic resin, polymethylmethacrylate resin, polyacrylonitrile resin, polyvinyl acetate resin, polyvinyl alcohol resin, polyvinyl butyral resin; polystyrene-based resins such as polystyrene resin, and styrene-acrylonitrile copolymer resin; halogenated olefin resin such as polyvinyl chloride; polyester-based resins such as polyethylene terephthalate resin, and polybutylene terephthalate resin; polycarbonate resin, polyethylene resin, polyvinyl fluoride resin, polyvinylidene fluoride resin, polytrifluoroethylene resin, polyhexafluoropropylene resin, copolymers of vinylidene fluoride and acrylic monomer, copolymers of vinylidene fluoride and vinyl fluoride; fluoroterpolymers such as terpolymer of tetrafluoroethylene, vinylidene fluoride and non-fluoro monomer; and silicone resins.

As necessary, a conductive powder etc. may be added, as a filler, in the coating resin. As the conductive powder or the like, for example, metal powder, carbon black, titanium oxide powder, tin oxide powder, zinc oxide powder, aluminum oxide powder, and a silica powder can be used. These conductive powders preferably have an average particle diameter of 1 μm or smaller. When the average particle diameter of the conductive powder is greater than 1 μm, control of electric resistance becomes difficult.

### [Image Forming Method/Apparatus]

An image forming method of the present invention includes at least charging a surface of an image bearing member, forming a latent electrostatic image on a surface of the image bearing member, developing the latent electrostatic image using a toner to form a visible image, transferring the visible image onto a recording medium to form an unfixed image, and fixing the unfixed image on the recording medium, wherein the toner for use in forming the visible image is the electrophotographic toner described above.

Here, even when a conveyance speed of the recording medium in the fixing is 280 mm/sec or higher, the electrophotographic toner can be excellently fixed on the recording medium.

According to the image forming method of the present invention, even when image formation is performed with an electrophotographic image forming apparatus having a high image output speed, it is possible to stably output high-quality images excellent in glossiness without causing after-image (ghost), because an electrophotographic toner, which has excellent low-temperature fixability and heat resistant storage stability even at high speed processing and can be fixed only desired portions of a recording medium without causing offset phenomena, is used.

An image forming apparatus of the present invention includes at least an image bearing member, a charging unit configured to charge a surface of the image bearing member, an exposing unit configured to expose the charged surface of the image bearing member to form a latent electrostatic image, a developing unit configured to develop the latent electrostatic image using a toner to form a visible toner image, a transfer unit configured to transfer the developed visible toner image onto a recording medium to from an unfixed image, and a fixing unit configured to fix the unfixed image on the recording medium, wherein the toner for use in forming the visible image is the electrophotographic toner described above.

Here, even when a conveyance speed of the recording medium in the fixing by the fixing unit is 280 mm/sec or higher, the electrophotographic toner can be excellently fixed on the recording medium.

According to the image forming apparatus of the present invention, it is possible to stably fixing images without causing abnormal images even at a high process linear speed, because an electrophotographic toner, which has excellent low-temperature fixability and heat resistant storage stability even at high speed processing and can be fixed only desired portions of a recording medium without causing offset phenomena, is used. For example, according to a tandem type full-color image forming apparatus of the present invention, high-quality images can be output at a further higher speed.

In addition, the image forming method and image forming apparatus of the present invention can be widely used in the field of electrophotography application (e.g., electrostatic copiers, and laser beam printers).

The following describes an embodiment of a tandem type full-color image forming appartus of the present invention, with reference to drawings.

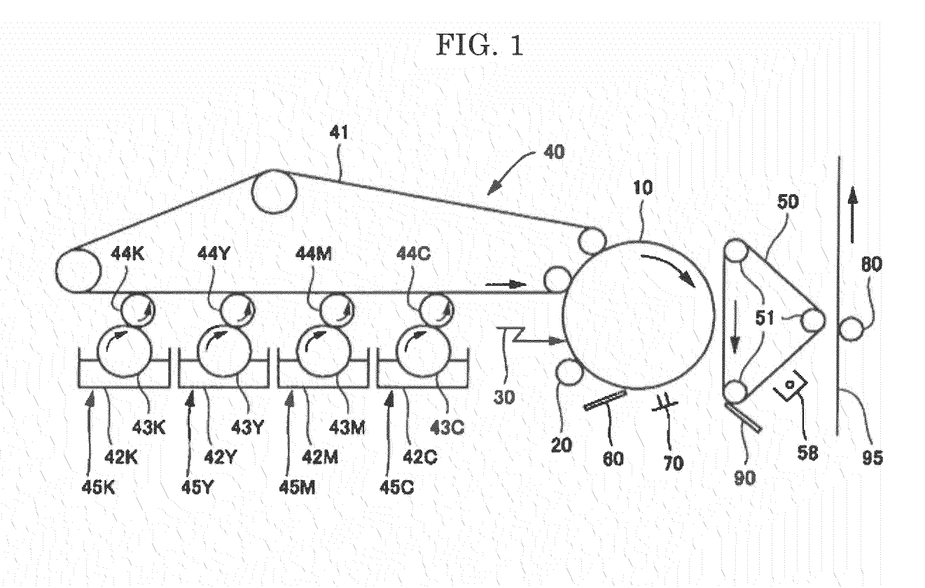

An image forming apparatus illustrated in FIG. 1 includes a photoconductor 10, a charger 20, an exposer 30, a developing device 40, an intermediate transfer member 50, a cleaner 60 having a cleaning blade, a charge eliminating device 70, and an image transferrer 80. Note that as the charger 20, a charging roller is used, as the charge eliminating device 70, a charge eliminating lamp is used, and as the image transferrer 80, a transfer roller is used.

The intermediate transfer member 50 is an endless belt and is designed such that the endless belt is spanned over three support rollers 51 which are disposed inside thereof and driven in the direction indicated by the arrow illustrated in the figure. At least one of the three rollers 51 also serves as a bias roller capable of applying a predetermined bias for image transfer (primary transfer bias) to the intermediate transfer member 50. An intermediate transfer member cleaner 90 having a cleaning blade is arranged near the intermediate transfer member 50. The transfer roller 80 serving as a transfer unit is arranged so as to face the intermediate transfer member 50 and is capable of applying a bias for image transfer (secondary transferring) for transferring a visible image (toner image) to a recording medium 95. A corona charger 58 for applying a charge to the visible image on the intermediate transfer member 50 is arranged around the intermediate transfer member 50. The corona charger 58 is disposed between a contact area of the photoconductor 10 with the intermediate transfer member 50 and another contact area of the intermediate transfer member 50 with the recording medium 95 in the rotational direction of the intermediate transfer member 50.

Note that a transfer sheet is used as the recording medium 95.

The developing device 40 includes a developing belt 41 serving as a developer bearing member, and a black-color developing unit 45K, a yellow-color developing unit 45Y, a magenta-color developing unit 45M and a cyan-color developing unit 45C which are arranged around the developing belt 41. Note that the developing unit 45K is equipped with a developer housing 42K, a developer supply roller 43K and a developing roller 44K; the developing unit 45Y is equipped with a developer housing 42Y, a developer supply roller 43Y and a developing roller 44Y; the developing unit 45M is equipped with a developer housing 42M, a developer supply roller 43M and a developing roller 44M; and the developing unit 45C is equipped with a developer housing 42C, a developer supply roller 43C and a developing roller 44C. The developing belt 41 is an endless belt and spanned over a plurality of belt rollers so as to be rotatable, and a part of which is in contact with the photoconductor 10.

In this image forming apparatus, the charger 20 uniformly charges a surface of the photoconductor 10, and then the exposer 30 imagewise exposes the surface of the photoconductor 10 to form a latent electrostatic image. Next, the developing device 40 develops the latent electrostatic image formed on the photoconductor 10 by supplying a developer thereto so as to form a visible image.

The visible image is transferred onto the intermediate transfer member 50 (primary transferring) by action of a transfer bias applied from the rollers 51 and then transferred onto the recording medium 95 (secondary transferring). As a result, a transferred image is formed on the recording medium 95. Note that a toner remaining on the photoconductor 10 is removed by the cleaner 60, and an electric charge on the photoconductor 10 is removed by the charge eliminating lamp 70.

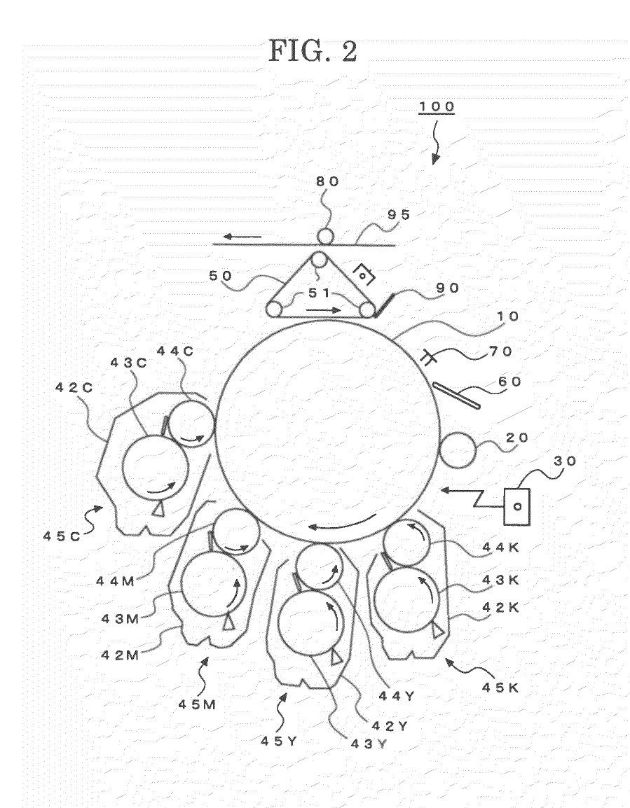

Next, another embodiment of an image forming apparatus of the present invention will be described with reference to FIG. 2. An image forming apparatus 100 illustrated in FIG. 2 includes the same components and has the same effects as those in the image forming apparatus illustrated in FIG. 1, except that instead of the developing device 40 illustrated in FIG. 1, a black-color developing unit 45K, a yellow-color developing unit 45Y, a magenta-color developing unit 45M and a cyan-color developing unit 45C are directly disposed around the photoconductor 10 so as to face the photoconductor 10.

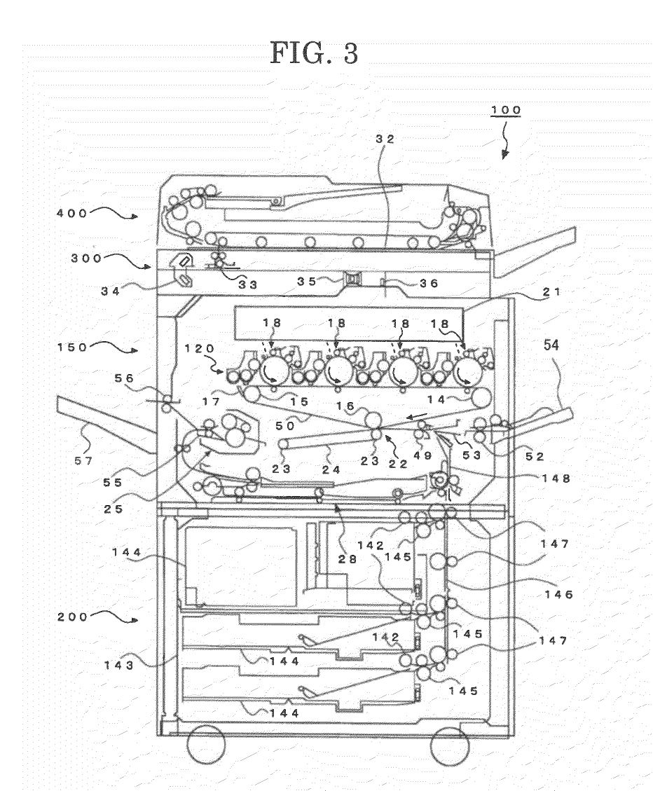

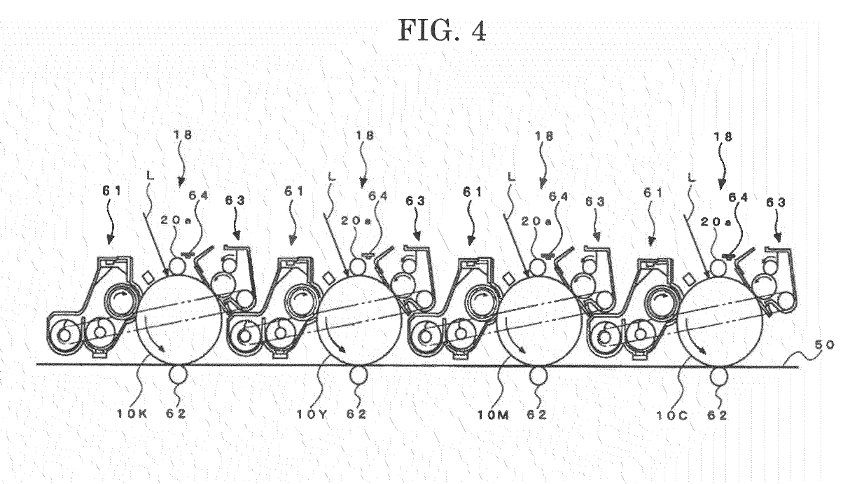

Note that in FIG. 2, the description of components provided with the same reference numerals as those of the image forming apparatus illustrated in FIG. 1 is omitted. The same applied to the after-mentioned image forming apparatuses illustrated in FIGS. 3 and 4.

Next, still another image forming apparatus of the present invention is described with reference to FIG. 3. An image forming apparatus 100 illustrated in FIG. 3 is a tandem type color image forming apparatus. This image forming apparatus includes a copier main body 150, a sheet-feeder table 200, a scanner 300, and automatic document feeder (ADF) 400.

The copier main body 150 is provided with an intermediate transfer member 50 formed in an endless belt at its center part. The intermediate transfer member 50 is spanned over three support rollers 14, 15, and 16 and is capable of rotating and moving in a clockwise direction in FIG. 3. An intermediate transfer member cleaner 17 capable of removing a residual toner on the intermediate transfer member 50 is arranged near the support roller 15. Above the intermediate transfer member 50 spanned between the support rollers 14 and 15, four (yellow, cyan, magenta, and black) image forming units 18 are arrayed in parallel in a moving direction of the intermediate transfer member 50 to thereby constitute an image forming unit 120. Near the image forming unit 120, an exposer 21 is placed. A secondary image transferrer 22 is arranged to face the image forming unit 120 with the interposition of the intermediate transfer member 50. The secondary transferrer 22 includes a secondary transfer belt 24 serving as an endless belt spanned over a pair of support rollers 23. A recording sheet being transported on the secondary transfer belt 24 is in contact with the intermediate transfer member 50. A fixing device 25 is arranged on the side of the secondary image transferer 22. The fixing device 25 includes a fixing belt 26 which is an endless belt, and a pressure roller 27 which is arranged so as to be pressed by the fixing belt 26. The tandem type image forming apparatus is further provided with a sheet reverser 28 in the vicinity of the secondary image transferer 22 and the fixing device 25. The sheet reverser 28 is capable of reversing the recording sheet so as to form images on both sides of the recording sheet.

Next, full-color image forming i.e. color copying using the image forming unit 120 will be described below. First, a document is placed on a document platen of the automatic document feeder (ADF) 400. Alternatively, the automatic document feeder (ADF) 400 is opened, a document is placed on a contact glass 32 of a scanner 300, and the automatic document feeder (ADF) 400 is closed to press the document.

When pushing a start switch (not illustrated), the document placed on the automatic document feeder 400 is transported onto the contact glass 32. When the document is initially placed on the contact glass 32, by pushing the start switch (not illustrated), the scanner 300 is immediately driven to operate a first carriage 33 and a second carriage 34. Light is applied from a light source to the document by action of the first carriage 33, and reflected light from the document is further reflected toward the second carriage 34. The reflected light is further reflected by a mirror of the second carriage 34 and passes through an image-forming lens 35 into a read sensor 36 to thereby read the color document (color image) and to produce black, yellow, magenta, and cyan image information. Next, the obtained image information of individual colors is transmitted to each of the image forming units 18 in the image forming unit 120, and visible images of individual colors of black, yellow, magenta and cyan are formed.

As illustrated in FIG. 4, image forming units 18 are each provided with a photoconductor 10; a charger 20a for uniformly charging a surface of the photoconductor 10; a developing device 61 configured to developing a latent electrostatic image, which has been formed by imagewise exposing the photoconductor 10 based on image information of individual colors by an exposer 21, using individual color toners (black toner, yellow toner, magenta toner, and cyan toner) to form visible images of the color toners; a transfer charger 62 for transferring the visible image onto an intermediate transfer member 50; a cleaner 63 and a charge eliminating device 64. The image forming units 18 are capable of forming visible images (visible toner images) of individual colors based on image information of the individual colors. Next, the individual color toner images thus formed are sequentially transferred in a superimposed manner onto the intermediate transfer member 50 (primary transferring) which rotationally moves by means of the support rollers 14, 15 and 16, and a composite toner image is formed on the intermediate transfer member 50.

One of feeder rollers 142 in the sheet-feeder table 200 is selectively rotated, recording sheets are ejected from one of multiple feeder cassettes 144 in paper bank 143, are separated by a separation roller 145 one by one, one recording sheet is sent into a feeder path 146, transported by transport rollers 147 into a feeder path 148 in the copier main body 150 and is bumped against a registration roller 49. Alternatively, feeder roller 142 is rotated to eject recording sheets on a manual bypass tray 54, the recording sheets are separated one by one by a separation roller 52, and one recording sheet is sent into a manual bypass feeder path 53 and then similarly bumped against the registration roller 49. The registration roller 49 is typically grounded, however, it may be used under application of a bias to remove paper dust of the recording sheets. The registration roller 49 is rotated in synchronization with the movement of the composite color image i.e. the transferred color image formed on the intermediate transfer member 50 to feed the sheet (recording paper) into between the intermediate transfer member 50 and the secondary image transferer 22, and the composite color image is transferred onto the recording sheet (secondary transferring) by the secondary image transferer 22, thereby forming a color image on the recording sheet. A residual toner remaining on the intermediate transfer member 50 is removed by the intermediate transfer member cleaner 17.

The recording sheet bearing the transferred composite color image is then transported by the secondary image transferer 22 to be fed into the fixing device 25, applied with heat and pressure in the fixing device 25, and the composite color image (color transfer image) is fixed on the recording sheet. Thereafter, the recording sheet changes its direction by action of a switch blade 55, ejected by an ejecting roller 56 to be stacked on an output tray 57. Alternatively, the recording sheet changes its direction by action of the switch blade 55 into a sheet reverser 28, turns therein, is transported again to the transfer position, followed by image formation on the back surface of the recording sheet. The recording sheet bearing images on both sides thereof is ejected through the ejecting roller 56 to be stacked on the output tray 57.

Since the tandem type image forming apparatus described above can transfer a plurality of toner images at a time, high-speed full-color printing can be realized.

The image forming units as described above may be incorporated in copiers, facsimiles and printers in a stationary manner or may be incorporated into their apparatus main bodies in the form of a process cartridge.

### [Process Cartridge]

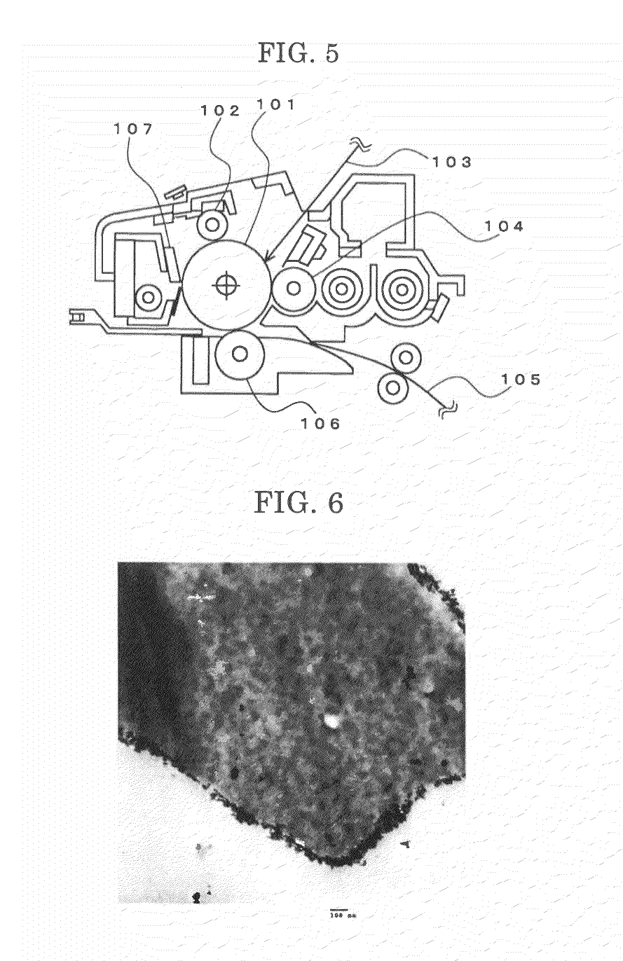

A process cartridge is a device (component) which incorporates an image bearing member (photoconductor) and includes at least one unit selected from a charging unit, an exposing unit, a developing unit, a transfer unit and a cleaning unit and which may includes other units, for example, a charge eliminating unit. There are many shapes and configurations for process cartridge. As a typical example, a process cartridge illustrated in FIG. 5 is exemplified.

In FIG. 5, the process cartridge incorporates a photoconductor (101), includes a charging unit (102), an exposing unit (103), a developing unit (104), and a cleaning unit (107), and further includes other units as required. In FIG. 5, reference numeral 105 denotes a recording medium (transfer sheet), and reference numeral 106 denotes a transfer unit.

That is, the process cartridge of the present invention includes an image bearing member, and at least one unit selected from a charging unit configured to charge a surface of the image bearing member, an exposing unit configured to expose a charged surface of the image bearing member to form a latent electrostatic image, a developing unit configured to develop a formed latent electrostatic image using a toner, a transfer unit configured to transfer a developed toner image onto a recording medium, and a cleaning unit configured to remove a residual toner remaining on a surface of the image bearing member after transfer of an image, the image bearing member and the at least one unit being integrally provided, wherein the process cartridge is detachably mounted to a main body of an image forming apparatus, and wherein the toner is an electrophotographic toner for use in the image formation is the image forming toner of the present invention. Note that when necessary, the process cartridge may include other units (e.g., a charge eliminating unit) as at least one selectable unit.

In the process cartridge of the present invention, the image forming toner of the present invention is supplied from a developing unit in the process cartridge, and thus the toner is stably fixed at only desired portions of a recording medium without causing offset phenomena due to unfixed images in a fixing unit, and it is possible to output high-quality images. Furthermore, the process cartridge is excellent in maintenance management, and enables easy transportation and easy handling.

### Exmaples

Hereinafter, the present invention will be further described in detail with reference to specific Examples, and Comparative Examples, however, however the present invention is not limited to the disclosed Examples. Note that the term “part(s)” in the following description means “part(s) by mass” unless otherwise specified.

### Example 1

### (Production of Pulverized Toner 1)

Polyester Resin 1 for use in the following formulation of toner was synthesized as follows.

### (Synthesis of Polyester Resin 1)

Into a reaction vessel equipped with a thermometer, a stirrer, a condenser and a nitrogen inlet tube, 443 parts of a PO adduct of bisphenol A (a product in which propylene oxide was added to bisphenol A: hydroxyl value=320), 135 parts of diethylene glycol, 422 parts of terephthalic acid and 2.5 parts of dibutyl tin oxide were charged and reacted at 230° C. until the acid value of the reaction product reached 7, thereby obtaining a resin. Further, into a reaction vessel equipped with a condenser tube, a stirrer and a nitrogen inlet tube, the resulting resin was charged in an amount of 410 parts, 89 parts of isophorone diisocyanate and 500 parts of ethyl acetate were added thereto and reacted at 100° C. for 5 hours to obtain Polyester Resin 1. The Polyester Resin 1 was found to have a peak molecular weight of 16,000.

### (Preparation of Masterbatch 1)

Next, a dispersion liquid (Masterbatch 1), in which a colorant had been uniformly dispersed in advance in a part of [Polyester Resin 1] for use in the formulation of toner, was prepared in the following manner.

The materials described in the following formulation of Masterbatch 1 were mixed at 1,500 rpm for 3 minutes using a HENSCHEL MIXER (HENSCHEL 20B, manufactured by Mitsui Mining Co., Ltd.) to obtain a mixture, and the mixture was kneaded with a two-roll at 120° C. for 45 minutes, rolled and cooled, and then pulverized with a pulverizer, thereby obtaining Masterbatch 1.

### (Formulation of Masterbatch 1).

water: 25 parts

Yellow Pigment No. 185 (produced by BASF Japan Ltd.): 50 parts

Polyester Resin 1: 50 parts

stearic acid amide (produced by Nippon Fine Chemical K.K.): 12.5 parts

### (Production of Pulverized Toner 1)

Polyester Resin 1 and Masterbatch 1 obtained as above and a carnauba wax were used to produce Pulverized Toner 1, according to the following formulation.

### (Formulation of Pulverized Toner 1)

Polyester Resin 1: 96 parts

carnauba wax: 5 parts

Masterbatch 1: 8 parts

The materials described in the above formulation of Pulverized Toner 1 were mixed at 1,500 rpm for 3 minutes using a HENSCHEL MIXER (HENSCHEL 20B, manufactured by Mitsui Mining Co., Ltd.) and then kneaded with a uniaxial kneader (compact size BUSS CO-KNEADER: manufactured by BUSS Inc.) under the following conditions to obtain [Base Toner 1].

Preset temperature: inlet temperature 90° C., outlet temperature 60° C.; rate of feed: 10 kg/Hr.

Further, [Base Toner 1] was cooled and rolled, pulverized with a pulverizer, and then the pulverized product was further finely pulverized with an I-type mill (IDS-2 Model: manufactured by Nihon Pneumatic Industry Co., Ltd.) using a flat-face collision board under the conditions: air pressure: 6.0 atm/cm², rate of feed: 0.5 kg/hr, followed by classification (using a classifier, 132MP, manufactured by Alpine American Corp., thereby obtaining [Toner Base Particle 1].

Thereafter, 100 parts of [Toner Base Particle 1], 1.0 part of a hydrophilic silica (external additive A) having a primary diameter of 10 nm, provided as an external additive, 1.0 part of a hydrophobization-treated hexamethyldisilazane (external additive B) which had been produced by a sol-gel method so as to have a primary particle diameter of 110 nm and a substantially spherical shape, and 1.0 part of a hydrophobic titanium oxide (external additive C) having a primary diameter of 15 nm were mixed by a HENSCHEL MIXER (HENSCHEL 20B, manufactured by Mitsui Mining Co., Ltd.), thereby obtaining [Pulverized Toner 1]. The above-mentioned materials were mixed at a circumferential speed of 30 m/sec for 30 seconds, and then the revolution was stopped for 60 seconds. This mixing treatment was repeated 5 times.

[Pulverized Toner 1] was found to have a weight average particle diameter (Dw) of 7.6 μm, a number average particle diameter (Dn) of 6.7 μm, and a glass transition temperature (Tg) of 63° C.

FIG. 6 is a microscope photograph of [Pulverized Toner 1] magnified at 50,000 times. In the microscope photograph, it is observed that the pigment appearing in black color was uniformly dispersed without aggregating in [Pulverized Toner 1].

### Example 2

### (Production of Polymerized Toner 2)

The following describes Examples of toner granulated with an aqueous medium.

### (Synthesis of Organic Fine Particle Emulsion)

Into a reaction vessel equipped with a stirrer and a thermometer, 683 parts of water, 11 parts of sodium salt of methacrylic acid ethylene oxide adduct sulfate ester (ELEMINOL RS-30, produced by Sanyo Chemical Industries, Ltd.), 83 parts of styrene, 83 parts of methacrylic acid, 110 parts butyl acrylate, and 1 part of ammonium persulfate were charged and then stirred at 400 rpm for 15 minutes to obtain a white liquid emulsion. Then, the temperature of the system was raised to 75° C. by heating and reacted for 5 hours. Further, 30 parts of a 1% ammonium persulfate aqueous solution was added to the system and aged at 75° C. for 5 hours to thereby obtain an aqueous dispersion liquid of vinyl resin (a copolymer of styrene methacrylate-butyl acrylate-sodium salt of methacrylic acid ethylene oxide adduct sulfate ester) [Fine Particle Dispersion Liquid 2]. The average particle diameter of [Fine Particle Dispersion Liquid 2] was measured by a LA-920 (laser diffraction/scattering type particle size distribution measuring device, manufactured by HORIBA Ltd.) and found to be 105 nm. A part of [Fine Particle Dispersion Liquid 2] was dried so that the resin parts were isolated therefrom. The resin was found to have a weight average molecular weight of 150,000.

### (Preparation of Aqueous Phase)

Water (990 parts), [Fine Particle Dispersion Liquid 2] (99 parts) and a 48.5% aqueous solution of sodium dodecyldiphenyl ether disulfonate (35 parts) (ELEMINOL MON-7, produced by Sanyo Chemical Industries, Ltd.) and ethyl acetate (70 parts) were mixed and stirred, thereby obtaining a white-milky liquid [Aqueous Phase 2].

### (Synthesis of Low Molecular Weight Polyester)

Into a reaction vessel equipped with a condenser tube, a stirrer and a nitrogen inlet tube, 229 parts of ethylene oxide (2 mol) adduct of bisphenol A, 529 parts of propylene oxide (3 mol) adduct of bisphenol A, 208 parts of terephthalic acid, 46 parts of adipic acid and 2 parts of dibutyltin oxide where added, reacted under normal pressure at 230° C. for 8 hours and further reacted under reduced pressure of 10 mmHg to 15 mmHg for 5 hours. Subsequently, 44 parts of trimellitic anhydride were added to the reaction vessel and reacted at 180° C. under normal pressure for 1.8 hours to obtain [Low Molecular Weight Polyester 2]. [Low Molecular Weight Polyester 2] was found to have a number average molecular weight of 2,500, a weight average molecular weight of 6,700, and a peak molecular weight of 5,000.

### (Synthesis of Intermediate Polyester)

Into a reaction vessel equipped with a condenser tube, a stirrer and a nitrogen inlet tube, 682 parts of ethylene oxide (2 mol) adduct of bisphenol A, 81 parts of propylene oxide (2 mol) adduct of bisphenol A, 283 parts of terephthalic acid, 22 parts of trimellitic anhydride and 2 parts of dibutyltin oxide were added, reacted under normal pressure at 230° C. for 8 hours and further reacted under reduced pressure of 10 mmHg to 15 mmHg for 5 hours to obtain [Intermediate Polyester 2]. [Intermediate Polyester 2] was found to have a number average molecular weight of 2,100, a weight average molecular weight of 9,500, a Tg of 55° C., an acid value of 0.5, and a hydroxyl value of 51.

### (Synthesis of Prepolymer 2)

Next, into a reaction vessel equipped with a condenser tube, a stirrer and a nitrogen inlet tube, 410 parts of [Intermediate Polyester 2], 89 parts of isophorone diisocyanate, 500 parts of ethyl acetate were charged and reacted at 100° C. for 5 hours to obtain [Prepolymer 2].

### (Synthesis of Ketimine)

Into a reaction vessel equipped with a stirrer and a thermometer, 170 parts of isophorone diamine and 75 parts of methylethylketone were charged and reacted at 50° C. for 5 hours to obtain [Ketimine Compound 2].

### (Production of Oil Phase)

Into a vessel equipped with a stirrer and a thermometer, 160 parts of [Low Molecular Weight Polyester 2], 32 parts of carnauba wax, and 400 parts of ethyl acetate were charged. The temperature of the reaction system was raised to 80° C. with stirring and maintained at 80° C. for 5 hours and then cooled to 30° C. over 1 hour.

Next, in the vessel, 45 parts of [Masterbatch 1] used in Example 1 and 40 parts of ethyl acetate were charged and mixed for 1 hour to obtain [Toner Material Solution 2] having a solid content of 50% by mass.

[Toner Material Solution 2] (464 parts) was transferred to a vessel, and the pigment and wax were dispersed with a bead mill (ULTRA VISCOMILL manufactured by Aimex Co., Ltd.) under the following conditions: liquid feed rate: 1 kg/hr, disc circumferential speed: 6 m/sec, 0.5 mm-zirconia bead filled at 80% by volume, and three passes. Subsequently, 420 parts of a 50% ethyl acetate solution of [Low Molecular Weight Polyester 2] were added to [Toner Material Solution 2] and passed through the bead mill once under the conditions described above, thereby obtaining [Pigment/Wax Dispersion Liquid 2].

### (Emulsification to Desolventation)

[Pigment/Wax Dispersion Liquid 2] (885 parts), 115 parts of [Prepolymer 2], 2.9 parts of [Ketimine Compound 2] were charted to a vessel, mixed at 5,000 rpm for 1 minute using a TK homomixer (manufactured by Tokush Kikai Kogyo Co. Ltd.), and then 1,200 parts of [Aqueous Phase 2] were added to the vessel and mixed at 12,500 rpm for 30 minutes using the TK homomixer to obtain [Emulsion Slurry 2].

In a vessel equipped with a stirrer and a thermometer, [Emulsion Slurry 2] was charged, the solvent was removed at 35° C. for 7 hours, and then aged at 45° C. for 4 hours to obtain [Dispersion Slurry 2]. A sample was transferred to the TK homomixer at some midpoint in the desolventation and stirred at 12,500 rpm for 40 minutes so that the toner had an irregular shape.

### (Washing to Drying)

After 100 parts of [Dispersion Slurry 2] was filtered under reduced pressure,
(1): 100 parts of ion exchanged water were added to the resulting filtration cake and mixed at 12,000 rpm for 10 minutes using a TK homomixer, followed by a filtration treatment. (2): Into the filtration cake prepared in (1), 100 parts of a 10% sodium hydroxide aqueous solution were added, mixed at 12,000 rpm for 30 minutes using a TK homomixer and filtered under reduced pressure. (3): Into the filtration cake prepared in (2), 100 parts of a 10% hydrochloric acid were added, mixed at 12,000 rpm for 10 minutes using a TK homomixer and then filtered. (4): Into the filtration cake prepared in (3), 300 parts by mass of ion exchanged water were added, mixed at 12,000 rpm for 10 minutes using a TK homomixer and then filtered. This process was repeated two times, thereby obtaining [Filtration Cake 2].

### (Production of Base Toner)

[Filtration Cake 2] was dried with a circular air-drier at 45° C. for 48 hours and sieved with a mesh with openings of 75 μm. Further, to 100 parts of the resulting particles, 0.6 parts of a charge controlling agent (E-84, metal salicylate, produced by Orient Chemical Industries Ltd.) were used and mixed at 1,000 rpm using a HENSCHEL MIXER, and further mixed at 5,500 rpm using a Q-type mixer (manufactured by Mitsui Metal Mining Co., Ltd.) so as to make the charge controlling agent adhere to the surface of the toner, thereby obtaining [Base Toner 2].

### (Addition of External Additive)

Next, to 100 parts of [Base Toner 2], 0.7 parts of a hydrophobic titanium oxide were added and mixed with a HENSCHEL MIXER to obtain [Polymerized Toner 2], and the production of toner was completed. [Polymerized Toner 2] was found to have a weight average particle diameter (Dw) of 5.2 μm, a number average particle diameter (Dn) of 4.6) μm, and a glass transition temperature (Tg) of 56° C.

### Example 3

### (Production of Pulverized Toner 3)

[Pulverized Toner 3] was obtained in the same manner as in Example 1, except that in the formulation of [Masterbatch 1], the amount of stearic acid amide was changed from 12.5 parts to 6.3 parts.

### Example 4

### (Production of Polymerized Toner 4)

[Polymerized Toner 4] was obtained in the same manner as in Example 2, except that in the formulation of [Masterbatch 1], the amount of stearic acid amide was changed from 12.5 parts to 6.3 parts.

### Example 5

### (Production of Pulverized Toner 5)

[Pulverized Toner 5] was obtained in the same manner as in Example 1, except that in the formulation of [Masterbatch 1], the amount of stearic acid amide was changed from 12.5 parts to 1.3 parts.

### Example 6

### (Production of Polymerized Toner 6)

[Polymerized Toner 6] was obtained in the same manner as in Example 2, except that in the formulation of [Masterbatch 1], the amount of stearic acid amide was changed from 12.5 parts to 1.3 parts.

### Example 7

### (Production of Pulverized Toner 7)

[Pulverized Toner 7] was obtained in the same manner as in Example 1, except that in the formulation of [Masterbatch 1], the amount of stearic acid amide was changed from 12.5 parts to 10 parts to produce [Masterbatch 7], and in the production of toner, the addition amount of [Masterbatch 7] was changed from 8 parts to 10 parts, and the addition amount of [Polyester Resin 1] was changed from 96 parts to 95 parts.

### Example 8

### (Production of Polymerized Toner 8)

Into a vessel equipped with a stirrer and a thermometer, 150 parts of [Low Molecular Weight Polyester 2], 32 parts of carnauba wax, and 400 parts of ethyl acetate were charged. The temperature of the system was raised to 80° C. with stirring and maintained at 80° C. for 5 hours, and then cooled to 30° C. over 1 hour. Next, in the vessel, 56 parts of [Masterbatch 7] used in Example 1 and 40 parts of ethyl acetate were charged and mixed for 1 hour to obtain [Toner Material Solution 8] having a solid content of 50% by mass.

[Toner Material Solution 8] (464 parts) was transferred to a vessel, and the pigment and wax were dispersed with a bead mill (ULTRA VISCOMILL manufactured by Aimex Co., Ltd.) under the following conditions: liquid feed rate: 1 kg/hr, disc circumferential speed: 6 m/sec, 0.5 mm-zirconia bead filled at 80% by volume, and three passes. Subsequently, 420 parts of a 50% ethyl acetate solution of [Low Molecular Weight Polyester 2] were added to [Toner Material Solution 8] and passed through the bead mill once under the conditions described above, thereby obtaining [Pigment/Wax Dispersion Liquid 8].

Subsequently, [Polymerized Toner 8] was obtained in the same manner as in Example 2, except that [Pigment/Wax Dispersion Liquid 8] described above was used instead of [Pigment/Wax Dispersion Liquid 2].

### Example 9

### (Production of Pulverized Toner 9)

[Pulverized Toner 9] was obtained in the same manner as in Example 1, except that in the formulation of [Masterbatch 1], the amount of stearic acid amide was changed from 12.5 parts to 8.3 parts to produce [Masterbatch 9], and in the production of toner, the addition amount of [Masterbatch 9] was changed from 8 parts to 12 parts, and the addition amount of [Polyester Resin 1] was changed from 96 parts to 94 parts.

### Example 10

### (Production of Polymerized Toner 10)

Into a vessel equipped with a stirrer and a thermometer, 140 parts of [Low Molecular Weight Polyester 2], 32 parts of carnauba wax, and 400 parts of ethyl acetate were charged. The temperature of the system was raised to 80° C. with stirring and maintained at 80° C. for 5 hours, and then cooled to 30° C. over 1 hour. Next, in the vessel, 68 parts of [Masterbatch 9] used in Example 9 and 40 parts of ethyl acetate were charged and mixed for 1 hour to obtain [Toner Material Solution 10] having a solid content of 50% by mass.

[Toner Material Solution 10] (464 parts) was transferred to a vessel, and the pigment and wax were dispersed with a bead mill (ULTRA VISCOMILL manufactured by Aimex Co., Ltd.) under the following conditions: liquid feed rate: 1 kg/hr, disc circumferential speed: 6 m/sec, 0.5 mm-zirconia bead filled at 80% by volume, and three passes. Subsequently, 420 parts of a 50% ethyl acetate solution of [Low Molecular Weight Polyester 2] were added to [Toner Material Solution 10] and passed through the bead mill once under the conditions described above, thereby obtaining [Pigment/Wax Dispersion Liquid 10].

Subsequently, [Polymerized Toner 10] was obtained in the same manner as in Example 2, except that [Pigment/Wax Dispersion Liquid 10] described above was used instead of [Pigment/Wax Dispersion Liquid 2].

### Example 11

### (Production of Pulverized Toner 11)

[Pulverized Toner 11] was obtained in the same manner as in Example 1, except that behenic acid amide was used instead of the stearic acid amide of [Masterbatch 1] used in Example 1.

### Example 12

### (Production of Polymerized Toner 12)

[Polymerized Toner 12] was obtained in the same manner as in Example 2, except that behenic acid amide was used instead of the stearic acid amide of [Masterbatch 1] used in Example 2.

### Example 13

### (Production of Pulverized Toner 13)

[Pulverized Toner 13] was obtained in the same manner as in Example 1, except that in the formulation of [Masterbatch 1], the amount of stearic acid amide was changed from 12.5 parts to 25 parts to produce [Masterbatch 13], and in the production of toner, the addition amount of [Masterbatch 13] was changed from 8 parts to 10 parts, and the addition amount of [Polyester Resin 1] was changed from 96 parts to 95 parts.

### Example 14

### (Production of Polymerized Toner 14)

[Masterbatch 13] of Example 13 was used to prepare [Pigment/Wax Dispersion Liquid 14] in the following manner.

Into a vessel equipped with a stirrer and a thermometer, 140 parts of [Low Molecular Weight Polyester 2], 32 parts of carnauba wax, and 400 parts of ethyl acetate were charged. The temperature of the system was raised to 80° C. with stirring and maintained at 80° C. for 5 hours, and then cooled to 30° C. over 1 hour. Next, in the vessel, 50 parts of [Masterbatch 13] and 40 parts of ethyl acetate were charged and mixed for 1 hour to obtain [Toner Material Solution 14] having a solid content of 50% by mass.

[Toner Material Solution 14] (469 parts) was transferred to a vessel, and the pigment and wax were dispersed with a bead mill (ULTRA VISCOMILL manufactured by Aimex Co., Ltd.) under the following conditions: liquid feed rate: 1 kg/hr, disc circumferential speed: 6 m/sec, 0.5 mm-zirconia bead filled at 80% by volume, and three passes. Subsequently, 420 parts of a 50% ethyl acetate solution of [Low Molecular Weight Polyester 2] were added to [Toner Material Solution 14] and passed through the bead mill once under the conditions described above, thereby obtaining [Pigment/Wax Dispersion Liquid 14].

Subsequently, [Polymerized Toner 14] was obtained in the same manner as in Example 2, except that [Pigment/Wax Dispersion Liquid 14] described above was used instead of [Pigment/Wax Dispersion Liquid 2].

### Comparative Example 1

### (Production of Pulverized Toner 15)

[Pulverized Toner 15] was obtained in the same manner as in Example 1, except that no stearic acid amide was added in the formulation of [Masterbatch 1].

### Comparative Example 2

### (Production of Polymerized Toner 16)

[Polymerized Toner 16] was obtained in the same manner as in Example 2, except that no stearic acid amide was added in the formulation of [Masterbatch 1].

### Comparative Example 3

### (Production of Pulverized Toner 17)

[Pulverized Toner 17] was obtained in the same manner as in Example 1, except that in the formulation of [Masterbatch 1], steric acid (produced by Cognis Oleo Chemicals) was added instead of the stearic acid amide.

### Comparative Example 4

### (Production of Polymerized Toner 18)

[Polymerized Toner 18] was obtained in the same manner as in Example 2, except that in the formulation of [Masterbatch 1], steric acid (produced by Cognis Oleo Chemicals) was added instead of the stearic acid amide.

### Example 15

### (Production of Pulverized Toner 19)

[Pulverized Toner 19] was obtained in the same manner as in Example 1, except that [Masterbatch 1′] used in Comparative Example 1, in which no stearic acid amide was added, was used, and in the melt-kneading of toner materials, the following formulation was used, in which stearic acid amide was added.

### (Formulation of Production of Pulverized Toner 19)

Polyester Resin 1: 96 parts

carnauba wax: 5 parts

Masterbatch 1 (stearic acid amide: not added): 8 parts

stearic acid amide: 1 part

### Example 16

### (Production of Polymerized Toner 20)

[Masterbatch 1′] used in Comparative Example 2, in which no stearic acid amide was added, was used to prepare [Pigment/Wax Dispersion Liquid 20] in the following manner.

Into a vessel equipped with a stirrer and a thermometer, 140 parts of [Low Molecular Weight Polyester 2], 32 parts of carnauba wax, and 400 parts of ethyl acetate were charged. The temperature of the system was raised to 80° C. with stirring and maintained at 80° C. for 5 hours, and then cooled to 30° C. over 1 hour. Next, in the vessel, 40 parts of [Masterbatch 1′] (stearic acid amide: not added), 5 parts of stearic acid amide and 40 parts of ethyl acetate were charged and mixed for 1 hour to obtain [Toner Material Solution 20] having a solid content of 50% by mass.

[Toner Material Solution 20] (469 parts) was transferred to a vessel, and the pigment and wax were dispersed with a bead mill (ULTRA VISCOMILL manufactured by Aimex Co., Ltd.) under the following conditions: liquid feed rate: 1 kg/hr, disc circumferential speed: 6 m/sec, 0.5 mm-zirconia bead filled at 80% by volume, and three passes. Subsequently, 420 parts of a 50% ethyl acetate solution of [Low Molecular Weight Polyester 2] were added to [Toner Material Solution 20] and passed through the bead mill once under the conditions described above, thereby obtaining [Pigment/Wax Dispersion Liquid 20].

Subsequently, [Polymerized Toner 20] was obtained in the same manner as in Example 2, except that [Pigment/Wax Dispersion Liquid 20] described above was used instead of [Pigment/Wax Dispersion Liquid 2].

### Comparative Example 5

### (Production of Pulverized Toner 21)

[Pulverized Toner 21] was obtained in the same manner as in Example 1, except that in the formulation of [Masterbatch 1], Color Index Number PY17 (produced by Toyo Ink Mfg. Co., Ltd.) was used instead of the yellow pigment No. 185.

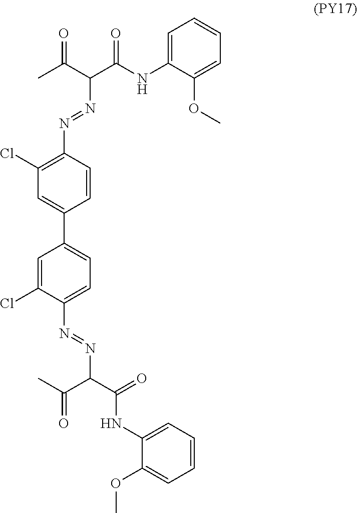

### Comparative Example 6

### (Production of Polymerized Toner 22)

[Polymerized Toner 22] was obtained in the same manner as in Example 2, except that in the formulation of [Masterbatch 1], Color Index Number PY17 (produced by Toyo Ink Mfg. Co., Ltd.) was used instead of the yellow pigment No. 185.

### Comparative Example 7

### (Production of Pulverized Toner 23)

[Pulverized Toner 23] was obtained in the same manner as in Example 1, except that in the formulation of (Production of Pulverized Toner 1), Color Index Number PY74 (produced by Dainichiseika Color & Chemicals Mfg. Co., Ltd.) was used instead of the yellow pigment No. 185.

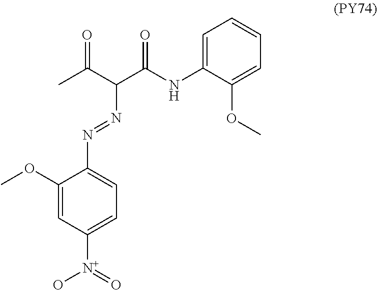

### Comparative Example 8

### (Production of Polymerized Toner 24)

[Polymerized Toner 24] was obtained in the same manner as in Example 2, except that in the formulation of [Masterbatch 1], Color Index Number PY74 (produced by Dainichiseika Color & Chemicals Mfg. Co., Ltd.) was used instead of the yellow pigment No. 185.

### Example 17

### (Production of Pulverized Toner 25)

[Pulverized Toner 25] was obtained in the same manner as in Example 1, except that Color Index Number PY139 was used instead of PY185 used in Pulverized Toner 1.

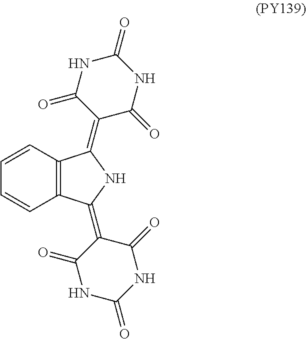

### Example 18

### (Production of Polymerized Toner 26)

[Polymerized Toner 26] was obtained in the same manner as in Example 2, except that Color Index Number PY139 was used instead of PY185 used in used in Polymerized Toner 2.

### Comparative Example 9

### (Production of Pulverized Toner 27)

[Pulverized Toner 27] was obtained in the same manner as in Example 1, except that in the formulation of (Production of Pulverized Toner 1), Color Index Number PR122 (produced by DIC Co.) was used instead of the yellow pigment No. 185.

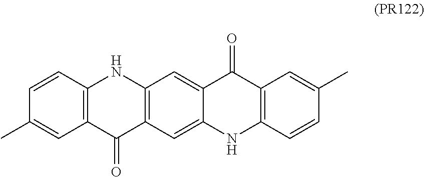

### Comparative Example 10

### (Production of Polymerized Toner 28)

[Polymerized Toner 28] was obtained in the same manner as in Example 2, except that in the formulation of [Masterbatch 1], Color Index Number PR122 (DIC Co.) was used instead of the yellow pigment No. 185.

### Comparative Example 11

### (Production of Pulverized Toner 29)

[Pulverized Toner 29] was obtained in the same manner as in Example 1, except that PR122 was used instead of PY185, and in the formulation of [Masterbatch 1], no stearic acid amide was added.

### Comparative Example 12

### (Production of Polymerized Toner 30)

[Polymerized Toner 30] was obtained in the same manner as in Example 2, except that PR122 was used instead of PY185, and in the formulation of [Masterbatch 1], no stearic acid amide was added.

### Example 19

### (Production of Pulverized Toner 31)

[Pulverized Toner 31] was produced in the same manner as in Example 1, except that the addition amounts of yellow pigment No. 185 and Polyester Resin 1 used in [Masterbatch 1] were changed to 20 parts and 80 parts, respectively (mixing ratio: pigment/resin=25 parts/100 parts) to prepare [Masterbatch A], and [Masterbatch A] was used in an amount of 32 parts and Polyester Resin 1 was used in an amount of 72 parts.

### Example 20

[Polymerized Toner 32] was produced in the same manner as in Example 2, except that instead of [Masterbatch 1] used in [Toner Material Solution 2] of [Polymerized Toner 2], [Masterbatch A] was added in an amount of 112.5 parts, and [Low Molecular Weight Polyester 2] was added in an amount of 92.5 parts.

### Example 21

[Pulverized Toner 33] was obtained in the same manner as in Example 1, except that in the formulation of [Masterbatch 1], the amount of stearic acid amide was changed from 12.5 parts to 24 parts.

### Example 22

[Polymerized Toner 34] was obtained in the same manner as in Example 2, except that in the formulation of [Masterbatch 1], the amount of stearic acid amide was changed from 12.5 parts to 24 parts.

### Example 23

[Pulverized Toner 35] was obtained in the same manner as in Example 1, except that the addition amount of [Masterbatch 1] was changed from 8 parts to 30 parts.

### Example 24

[Polymerized Toner 36] was obtained in the same manner as in Example 2, except that the amount of [Masterbatch 1] added in [Toner Material Solution 2] was changed from 45 parts to 169 parts and the addition amount of [Low Molecular Weight Polyester 2] was changed from 160 parts to 76 parts.

### [Evaluation]

The toners obtained in the above were used to evaluate fixed images, storage stability of the toners and then subjected to an overall evaluation according to the following evaluation methods. The evaluation results are shown in Tables 1-1 to 1-3. Note that the addition amounts described in Tables 1-1 and 1-2 are values relative to 100 parts of all resins used.

### (Evaluation Method of Fixed Image)

The evaluation of fixed images was carried out using a copier, IMAGEO NEO C600 manufactured by Ricoh Company Ltd. Specifically, each of the [Pulverized Toners] and [Polymerized Toners] was mixed with a carrier for use in the copier to perform the following image evaluation test.

First, an image in the form of a rectangle (3 cm×5 cm) was formed on an A4-size recording sheet (T6000 70W, along the wales direction, produced by Ricoh Company Ltd.) with a toner adhesion amount of 0.4 mg/cm² at a position of 3 cm from the end of the recording sheet to prepare a toner sample. Subsequently, the image (toner sample) was fixed on the recording sheet at a linear velocity of 280 mm/sec while the temperature of the fixing member was constantly controlled to be 160° C. Next, the fixed image was evaluated for its tinting power (degree of coloring) with an X-Rite (manufactured by X-Rite Inc.) in mode status A. When the value of yellow ID, which is a standard image density, was 1.5 or more, the toner was graded as (A); when the value was 1.3 or more and less than 1.5, the toner was evaluated as “good” (B);

when the value was less than 1.3 and 1.2 or more, the toner was evaluated as “slightly good” (C); and when the value was less than 1.2, the toner was evaluated as “poor” (D).

### (Evaluation of Storage Stability of Toner)

Each of the [Pulverized Toners] and [Polymerized Toners] was dried at 50° C. for 24 hours in a commercially available drier (manufactured by Yamato K.K.) and then visually evaluated whether the toner had become solid. A toner which had not become solid was graded as “A”; a toner, in which slight solidification was observed, was graded as “B”; and a toner, in which a considerable amount of solid particles was observed, was graded as “C”.

### (Overall Evaluation)

In view of the above evaluation results, toners having an yellow ID grade of C or higher and a storage stability grade of B or higher were evaluated as satisfying the conditions of the present invention (acceptable: A); and toners other than the toners evaluated as “acceptable: A” were regarded as “unacceptable: B).

TABLE 1-1

| | | Dispersant | | Pigment | | | | |
|---|---|---|---|---|---|---|---|---|
| | | | Addition | | Addition | Evaluation Result | | |
| | | Fatty acid | amount | Name of | amount | | Storage | |
| | Type of toner | amide compound | (part) | pigment | (part) | ID | stability | Grade |
| Ex. 1 | Pulverized Toner 1 | stearic acid amide | 1.0 | PY185 | 4.0 | A | A | A |
| Ex. 2 | Polymerized Toner 2 | stearic acid amide | 1.0 | PY185 | 4.0 | B | A | A |
| Ex. 3 | Pulverized Toner 3 | stearic acid amide | 0.5 | PY185 | 4.0 | A | A | A |
| Ex. 4 | Polymerized Toner 4 | stearic acid amide | 0.5 | PY185 | 4.0 | B | A | A |
| Ex. 5 | Pulverized Toner 5 | stearic acid amide | 0.1 | PY185 | 4.0 | B | A | A |
| Ex. 6 | Polymerized Toner 6 | stearic acid amide | 0.1 | PY185 | 4.0 | B | A | A |
| Ex. 7 | Pulverized Toner 7 | stearic acid amide | 1.0 | PY185 | 5.0 | A | A | A |
| Ex. 8 | Polymerized Toner 8 | stearic acid amide | 1.0 | PY185 | 5.0 | B | A | A |
| Ex. 9 | Pulverized Toner 9 | stearic acid amide | 1.0 | PY185 | 6.0 | A | A | A |
| Ex. 10 | Polymerized Toner 10 | stearic acid amide | 1.0 | PY185 | 6.0 | A | A | A |
| Ex. 11 | Pulverized Toner 11 | behenic acid | 1.0 | PY185 | 4.0 | A | A | A |
| | | amide | | | | | | |
| Ex. 12 | Polymerized Toner 12 | behenic acid | 1.0 | PY185 | 4.0 | B | A | A |
| | | amide | | | | | | |
| Ex. 13 | Pulverized Toner 13 | stearic acid amide | 2.0 | PY185 | 4.0 | A | B | A |
| Ex. 14 | Polymerized Toner 14 | stearic acid amide | 2.0 | PY185 | 4.0 | B | B | A |

TABLE 1-2

| | | Dispersant | | Pigment | | | | |
|---|---|---|---|---|---|---|---|---|
| | | | Addition | | Addition | Evaluation Result | | |
| | | Fatty acid | amount | Name of | amount | | Storage | |
| | Type of toner | amide compound | (part) | pigment | (part) | ID | stability | Grade |
| Comp. Ex. 1 | Pulverized Toner 15 | Not added | — | PY185 | 4.0 | D | A | B |
| Comp. Ex. 2 | Polymerized Toner 16 | Not added | — | PY185 | 4.0 | D | A | B |
| Comp. Ex. 3 | Pulverized Toner 17 | stearic acid amide | 1.0 | PY185 | 4.0 | C | C | B |
| Comp. Ex. 4 | Polymerized Toner 18 | stearic acid amide | 1.0 | PY185 | 4.0 | D | A | B |
| Ex. 15 | Pulverized Toner 19 | stearic acid amide | 1.0 | PY185 | 4.0 | C | A | A |
| | | (not premixed with | | | | | | |
| | | pigment) | | | | | | |
| Ex. 16 | Polymerized Toner 20 | stearic acid amide | 1.0 | PY185 | 4.0 | C | A | A |
| | | (not premixed with | | | | | | |
| | | pigment) | | | | | | |
| Comp. Ex. 5 | Pulverized Toner 21 | stearic acid amide | 1.0 | PY17 | 4.0 | D | A | B |
| Comp. Ex. 6 | Polymerized Toner 22 | stearic acid amide | 1.0 | PY17 | 4.0 | D | A | B |
| Comp. Ex. 7 | Pulverized Toner 23 | stearic acid amide | 1.0 | PY74 | 4.0 | C | A | B |
| Comp. Ex. 8 | Polymerized Toner 24 | stearic acid amide | 1.0 | PY74 | 4.0 | D | A | B |
| Ex. 17 | Pulverized Toner 25 | stearic acid amide | 1.0 | PY139 | 4.0 | A | A | A |
| Ex. 18 | Polymerized Toner 26 | stearic acid amide | 1.0 | PY139 | 4.0 | A | A | A |
| Comp. Ex. 9 | Pulverized Toner 27 | stearic acid amide | 1.0 | PR122 | 4.0 | C | A | A |
| Comp. Ex. | Polymerized Toner 28 | stearic acid amide | 1.0 | PR122 | 4.0 | D | A | B |
| 10 | | | | | | | | |
| Comp. Ex. | Pulverized Toner 29 | Not added | 1.0 | PR122 | 4.0 | C | A | A |
| 11 | | | | | | | | |
| Comp. Ex. | Polymerized Toner 30 | Not added | 1.0 | PR122 | 4.0 | D | A | B |
| 12 | | | | | | | | |

TABLE 1-3

Evaluation Result

| | | | Storage | |
|---|---|---|---|---|
| | Type of toner | ID | stability | Grade |
| Ex. 19 | Pulverized Toner 31 | A | A | A |
| Ex. 20 | Polymerized Toner 32 | B | A | A |
| Ex. 21 | Pulverized Toner 33 | A | A | A |
| Ex. 22 | Polymerized Toner 34 | B | A | A |
| Ex. 23 | Pulverized Toner 35 | A | A | A |
| Ex. 24 | Polymerized Toner 36 | A | A | A |

As shown in Tables 1-1 and 1-2, the [Pulverized Toners] and [Polymerized Toners] produced in Examples 1 to 18 satisfied all the above requirements and were evaluated as “acceptable”, whereas all the [Pulverized Toners] and [Polymerized Toners] produced in Comparative Examples 1 to 8 were evaluated as “unacceptable” in the overall evaluation.

In addition, as shown in Comparative Examples 9 to 12, no effect of stearic acid amide was noticed on the magenta pigment PR122.

What is claimed is:

1. A toner colorant comprising:
a pigment represented by General Formula (1) described below, and
a fatty acid amide compound, 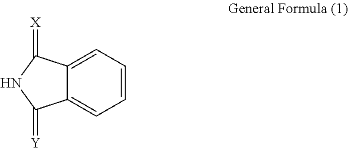
where X and Y are independently selected from the following structures: 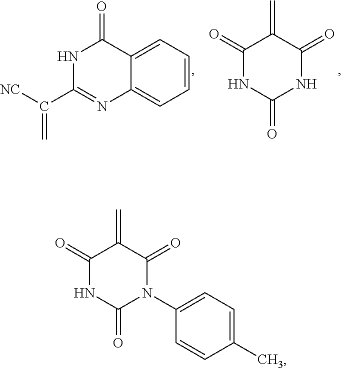
═C(CN)—CONH—CH₃,
═C(CN)—CONH—(C₆H₄)—Z, and
═C(CN)—CONH—(C₆H₃)—Z₂,
where Z denotes one of an alkyl group having 1 to 4 carbon atoms, an alkoxy group and a halogen atom.

2. The toner colorant according to claim 1, wherein the amount of the fatty acid amide compound is 12.5 parts by mass to 50 parts by mass per 100 parts by mass of the pigment.

3. The toner colorant according to claim 1, wherein the pigment is Color Index Number PY185.

4. The toner colorant according to claim 1, wherein the pigment is Color Index Number PY139.

5. The toner colorant according to claim 1, wherein the fatty acid amide compound is one of stearic acid amide and behenic acid amide.

6. An electrophotographic toner comprising:
a colorant, and
a binder resin,
wherein the colorant comprises at least a pigment represented by General Formula (1) described below and a fatty acid amide compound, 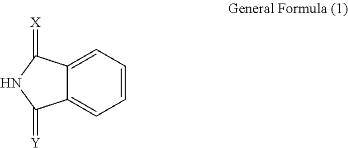
where X and Y are independently selected from the following structures: 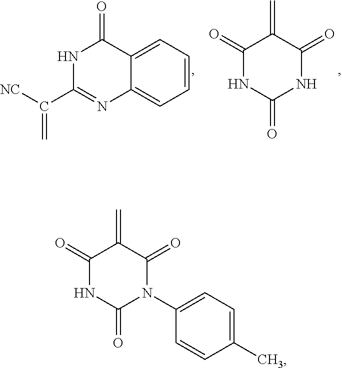
═C(CN)—CONH—CH₃,
═C(CN)—CONH—(C₆H₄)—Z, and
═C(CN)—CONH—(C₆H₃)—Z₂,
where Z denotes one of an alkyl group having 1 to 4 carbon atoms, an alkoxy group and a halogen atom.

7. The electrophotographic toner according to claim 6, wherein the electrophotographic toner is produced using a masterbatch which is obtained by previously melt-kneading the binder resin, the pigment and the fatty acid amide compound.

8. The electrophotographic toner according to claim 7, wherein the proportion of the pigment to the binder resin, in the masterbatch, is 25 parts by mass to 100 parts by mass per 100 parts by mass of the binder resin.

9. The electrophotographic toner according to claim 6, wherein the pigment is Color Index Number PY185.

10. The electrophotographic toner according to claim 6, wherein the pigment is Color Index Number PY139.

11. The electrophotographic toner according to claim 6, wherein the fatty acid amide compound is one of stearic acid amide and behenic acid amide.

12. The electrophotographic toner according to claim 6, wherein the amount of the fatty acid amide compound is less than 2.0 parts by mass per 100 parts by mass of all resins used.

13. The electrophotographic toner according to claim 6, wherein the pigment is contained in an amount of 1% by mass to 15% by mass.

14. The electrophotographic toner according to claim 6, wherein the amount of the fatty acid amide compound is 12.5 parts by mass to 50 parts by mass per 100 parts by mass of the pigment.

15. A two-component developer comprising:
an electrophotographic toner, and
a carrier,
wherein the electrophotographic toner comprises at least a colorant, and a binder resin, and
wherein the colorant comprises at least a pigment represented by General Formula (1) described below and a fatty acid amide compound, 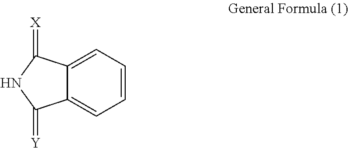
where X and Y are independently selected from the following structures: 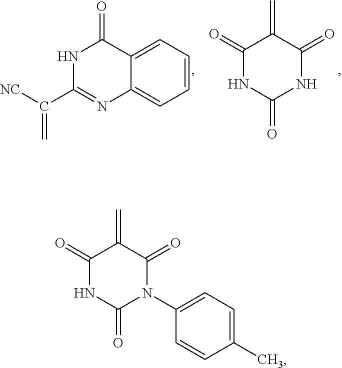
═C(CN)—CONH—CH₃,
═C(CN)—CONH—(C₆H₄)—Z, and
═C(CN)—CONH—(C₆H₃)—Z₂,
where Z denotes one of an alkyl group having 1 to 4 carbon atoms, an alkoxy group and a halogen atom.
